(19) United States
(12) Patent Application Publication
(10) Pub. No.: US 2026/0205970 A1
(43) Pub. Date: Jul. 16, 2026

(54) FREQUENCY MODULATED CONTINUOUS WAVE SYNCHRONIZATION SIGNAL DESIGN FOR MULTIPLE CELLS

(71) Applicant: QUALCOMM Incorporated, San Diego, CA (US)

(72) Inventors: Weimin DUAN, San Diego, CA (US); Jing SUN, San Diego, CA (US); Kangqi LIU, San Diego, CA (US)

(21) Appl. No.: 19/019,440

(22) Filed: Jan. 13, 2025

(51) Int. Cl. H04W 56/00; H04W 24/08; H04W 72/0446; H04W 72/0453

(52) U.S. Cl. CPC H04W 56/0015; H04W 24/08; H04W 72/0446; H04W 72/0453

(57) ABSTRACT

Certain aspects of the present disclosure provide techniques for wireless communications. An example method includes obtaining, via a first cell, a first synchronization signal comprising a first frequency-modulated continuous wave (FMCW) waveform, the first FMCW waveform comprising a first FMCW signal with a first slope that linearly increases in time and a second FMCW signal with a second slope that linearly decreases in time; obtaining, via at least a second cell, at least a second synchronization signal comprising a second FMCW waveform, the second FMCW waveform comprising a third FMCW signal with the first slope or the second slope; and monitoring for a first synchronization signal block (SSB) corresponding to the first cell or a second SSB corresponding to the second cell based on the first synchronization signal and the at least second synchronization signal.

### INTRODUCTION

### Field of the Disclosure

Aspects of the present disclosure relate to wireless communications, and more particularly, to techniques for synchronization signal designs in wireless communication networks for multiple cells.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining, via a first cell, a first synchronization signal comprising a first frequency-modulated continuous wave (FMCW) waveform, the first FMCW waveform comprising a first FMCW signal with a first slope that linearly increases in time and a second FMCW signal with a second slope that linearly decreases in time; obtaining, via at least a second cell, at least a second synchronization signal comprising a second FMCW waveform, the second FMCW waveform comprising a third FMCW signal with the first slope or the second slope; and monitoring for a first synchronization signal block (SSB) corresponding to the first cell or a second SSB corresponding to the second cell based on the first synchronization signal and the at least second synchronization signal.

Certain aspects provide a method for wireless communications by a network entity. The method includes sending, via a first cell, a first synchronization signal comprising a first FMCW waveform, the first FMCW waveform comprising a first FMCW signal with a first slope that linearly increases in time and a second FMCW signal with a second slope that linearly decreases in time; sending, via at least a second cell, at least a second synchronization signal comprising a second FMCW waveform, the second FMCW waveform comprising a third FMCW signal with the first slope or the second slope; and sending a first SSB corresponding to the first cell and a second SSB corresponding to the second cell based on the first synchronization signal and the at least second synchronization signal.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5A depicts an example frequency modulated continuous wave (FMCW)-based synchronization signal.

FIG. 5B depicts an example FMCW-based synchronization signal.

FIG. 5C depicts an example of receiver-side processing of an FMCW waveform.

FIGS. 6A and 6B depict an example of FMCW detector output processing.

FIG. 7 depicts example FMCW-based synchronization signals.

FIG. 8 depicts an example wireless communications network.

FIG. 9 depicts example FMCW-based synchronization signals.

FIG. 10 depicts example FMCW-based synchronization signals.

FIG. 11 depicts a process flow for communications in a network between a network entity and a UE.

FIG. 12 depicts a method for wireless communications.

FIG. 13 depicts another method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for frequency modulated continuous wave (FMCW) waveforms as synchronization signals to support multiple cells with a single-frequency network (SFN).

A wireless communication system may include a number of devices and network entities employing techniques for exchanging information wirelessly. For example, a wireless communication system may include devices (e.g., user equipments (UEs)) and network entities (e.g., base stations (BSs)) that wirelessly communicate data, control information, reference signals, etc. (e.g., according to various wireless communication system implementations). The wireless communication system may employ various technologies to improve throughput, achieve a high data rate, and/or improve the energy efficiency of the wireless communication system. These technologies may allow a wireless communication system to support communication between an increasing number of devices and network entities, support advanced functionalities at various devices, and improve the quality of communication between devices and network entities.

In some wireless communication systems, such as those specified under standards for 5G New Radio (NR), 6G, and other standards, a network entity may communicate with a UE within a cell and/or via a cell. The network entity may broadcast SS/physical broadcast control channel (PBCH) blocks (SSBs) in the cell at regular intervals based on a configured periodicity (e.g., 20 milliseconds (ms)). A number of SSBs, referred to as an SSB burst set, are typically transmitted in different directions (e.g., on different beams) during a five ms SSB burst time period. For example, in millimeter wave (mmW) systems (e.g., FR2 systems), up to sixty-four SSBs may be transmitted in an SSB burst.

An SSB may include a primary synchronization signal (PSS), a secondary synchronization signal (SSS), and a PBCH. From the PSS and SSS, time synchronization (e.g., radio frame, subframe, slot, and/or symbol synchronization) may be achieved in the cell in the time domain. The PBCH in the SSB may further include a master information block (MIB) that defines various system information, along with parameters for decoding a system information block (SIB). The SIB may be, for example, a SystemInformationType 1 (SIB1) that may include various remaining minimum system information (RMSI) for initial access.

Additionally, the PSS and SSS may collectively identify the physical cell identity (PCI) of the cell (e.g., an identifier specific to the cell). For example, in NR, 1008 PCIs may be divided into 336 unique PCI groups, and each PCI group may include three different identities. Subsequently, a PCI (e.g., denoted as N_{ID}^{Cell}) may be determined according to Equation 1 provided below:

$${N}_{ID}^{C ell} = 3 ⋆ {N}_{ID}^{( 1 )} + {N}_{ID}^{( 2 )} \qquad ( 1 )$$

where N_{ID}⁽¹⁾∈{0, 1, . . . , 335} and N_{ID}⁽²⁾∈{0, 1, 2}. The PSS may assist the UE in determining a physical-layer identity (e.g., N_{ID}⁽²⁾) and synchronization up to the periodicity of the PSS. The number of N_{ID}⁽²⁾ candidates may be three to support a topology-based three sector deployment.

Periodic transmission of SSBs may consume a significant amount of energy at the network entity. Therefore, a simple downlink reference signal, referred to herein as a light SSB (e.g., only a PSS), may be transmitted frequently to facilitate UE initial cell search, followed by less frequent actual SSB (or modified SSBs without the PSS) transmissions. When a UE detects the light SSB, the UE is aware of the cell deployment and can stay on a synchronization (sync) raster point longer to look for the actual SSB. As such, in some aspects, the light SSB may be referred to as a pre-SSB PSS design.

FMCW waveforms have been proposed for the light SSB, such that the light SSB may be referred to as a pre-SSB FMCW-based PSS design. By using an FMCW-based light SSB waveform (e.g., to represent a PSS), the UE can scan multiple sync raster points at a time, with relatively low complexity. “FMCW” generally refers to a signal where the frequency increases linearly with time (referred to as an up-chirp) or decreases linearly with time (referred to as a down-chirp). In FMCW, a difference between the transmitted signal carrier frequency and the received signal carrier frequency is referred to as a beat frequency. FMCW processing may allow channel estimation to be performed over an entire operating bandwidth, even if a UE does not support the full operating bandwidth, using narrowband baseband processing. For example, using FMCW as a downlink channel sounding reference signal, a UE with limited capability to support a relatively limited frequency range (e.g., 20 MHz, 100 MHz, 400 MHz, 1 GHz, etc.) may be able to perform wideband channel estimation for ultra-wide system bandwidth (e.g., 400 MHz to 8 GHz).

However, FMCW waveforms may suffer from potential time and frequency offset ambiguity. For example, a frequency offset (e.g., due to oscillator offset) and timing offset may not be distinguishable at the PSS detector output at the receiver. In some aspects, the “frequency offset” may generally refer to the difference between the frequency of a received signal and the frequency of a local oscillator at the receiver. In 5G NR systems, frequency offset estimation is performed in order to compensate for frequency offset, to maintain timing and frequency synchronization. In wireless systems, such as 5G, various types of SSs (e.g., PSSs and SSSs) may be used to perform frequency (e.g., phase) and time compensation. In some aspects, the beat frequency of a first PSS candidate (PSS candidate 1) and of a second PSS candidate (PSS candidate 2) may appear to be the same within a searching window. This appearance of the beat frequencies being the same for the different PSS candidates may make the UE unable to determine a frequency offset and time offset relative to the receiver-local FMCW, which makes the frequency/time synchronization coarse. As a result, precise frequency estimation and timing estimation may need to rely on another type of waveform, such as an SSS using a cyclic prefix orthogonal frequency division multiplexing (CP-OFDM) waveform.

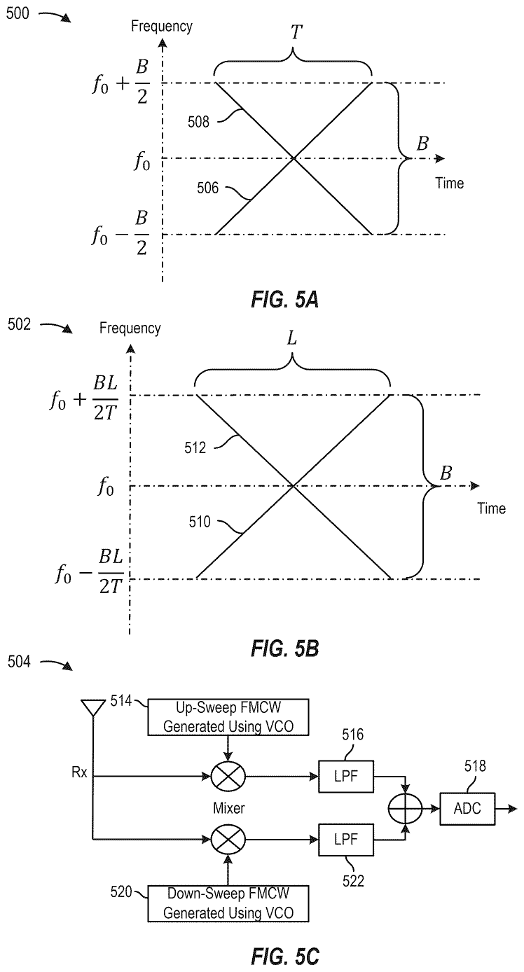

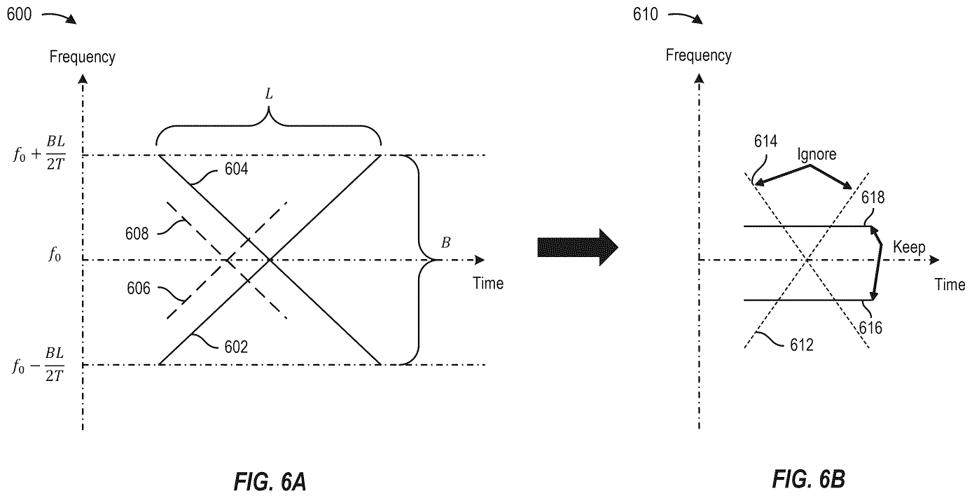

In some aspects, an FMCW-based synchronization signal design may be used to help remove the aforementioned ambiguity. For example, an FMCW-based PSS (e.g., FMCW waveform that serves as a PSS) may be formed using a first FMCW signal with an associated frequency that increases (ramps up) linearly in time and a second FMCW signal with an associated frequency that decreases (ramps down) linearly in time. That is, the first FMCW signal may be concatenated in time with the second FMCW signal to form the FMCW-based PSS. In some aspects, the first FMCW signal may increase linearly in time according to a first slope, and the second FMCW signal may decrease linearly in time according to a second slope, where the second slope corresponds to a negative of the first slope (e.g., a first slope of Z and a second slope of negative Z). That is, the first slope and the second slope may have a same absolute slope value but with opposite slope directions. In some aspects, by using a same up-sweep ramp (e.g., for the first slope) and down-sweep ramp (e.g., for the second slope), the first FMCW signal and the second FMCW signal may form an “X” shape. Additionally, a center of the “X” shape may be defined as a sync raster point (e.g., denoted as f₀) for a corresponding synchronization signal (e.g., PSS) formed thereby. The X-shaped FMCW-based PSS is depicted and described in greater detail with respect to FIGS. 5A-6B.

Additionally or alternatively, the first FMCW signal and the second FMCW signal may form a “V” shape. For example, the first FMCW signal and the second FMCW signal may have a same bandwidth (B) with a center frequency (e.g., f₀) corresponding to a sync raster point for a corresponding synchronization signal (e.g., PSS) formed thereby. Additionally, each of the first FMCW signal and the second FMCW signal may have the same bandwidth (B) and a same time-sweeping duration and same absolute slope value. For example, the total time duration for down-sweeping and up-sweeping may be represented as T, with each of the down-sweep time duration and the up-sweep time duration corresponding to T/2, and the absolute slope value of each of the first and second FMCW signals corresponding to

$$B / ( \frac{T}{2} )$$

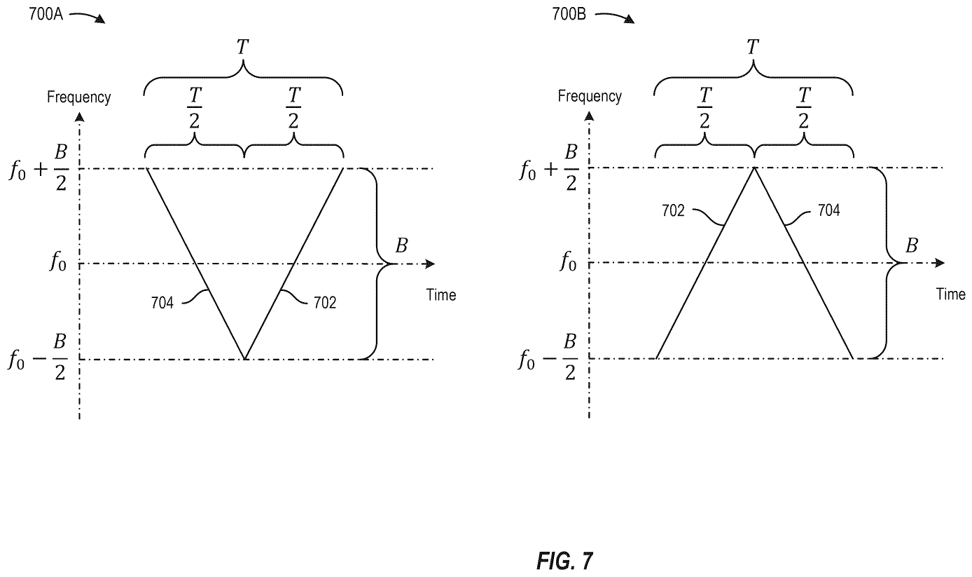

(e.g., the slope of the first FMCW signal is B/(T/2) and the slope of the second FMCW signal is −B/(T/2)). The resulting V-shaped FMCW-based PSS design may reduce the time/frequency offset ambiguity, maintain a low (e.g., 0 dB) peak-to-average-power ratio (PAPR), and maintain a high signal-to-noise ratio (SNR) for each of the first FMCW signal and the second FMCW signal. The V-shaped FMCW-based PSS is depicted and described in greater detail with respect to FIG. 7.

Each of the first FMCW signal and the second FMCW signal may have the same duration or different durations. For example, one of the FMCW signals may have a duration equal to an integer multiple or a fraction (e.g., with an integer denominator) of the duration of the other FMCW signal. In some aspects, the first FMCW signal and the second FMCW signal may have the same absolute slope value (with opposite slope signs) as described previously. In other aspects, the first FMCW signal and the second FMCW signal may have different absolute slope values (with opposite slope signs).

In some aspects, a receiving device (e.g., a receiver at the UE) may include two signal paths, one for each of the first FMCW signal and the second FMCW signal. For example, a receiving device (e.g., a receiver at the UE) may apply a first locally generated FMCW signal (e.g., an up-sweep FMCW signal or a down-sweep FMCW signal) to a received FMCW waveform (e.g., FMCW-based PSS) during one or more first search windows to detect a beat frequency between the first locally generated FMCW signal and the FMCW waveform. Upon detecting the beat frequency, the receiving device may then apply a second locally generated FMCW signal having the opposite direction sweep than the first locally generated FMCW signal to the FMCW waveform during one or more additional search windows to detect an additional beat frequency. The receiving device may then perform frequency and time estimation (e.g., determining the frequency and time offset) based on the detected beat frequencies to help remove the aforementioned time and frequency offset ambiguity.

One or more technical problems arise for FMCW-based synchronization signals (e.g., FMCW-based PSSs). For example, if multiple cells are available for communications with a UE, signaling may not be defined for separate FMCW-based synchronization signals for each cell of the multiple cells. Additionally or alternatively, if separate FMCW-based synchronization signals for each cell are transmitted, the UE may be unable to determine and/or differentiate which FMCW-based synchronization signals are sent via different cells. In some aspects, the multiple cells may be part of an SFN, and the UE may be unable to determine and/or differentiate separate FMCW-based synchronization signals that are sent via the different cells. For example, a SFN may include a wireless communications network where all transmitting devices (e.g., network entities and/or cells) simultaneously broadcast same data on a same frequency. That is, in an SFN, all transmitting devices may deliver same data or content at the same frequency in a synchronized manner. As such, an SFN may effectively create a synchronized signal across multiple network entities (e.g., cell towers). In some aspects, for an SFN, multiple network entities and/or cells may act like a single, large transmitting device by transmitting a same signal at a same time. SFNs may enhance wireless communications coverage, which may be useful for scenarios where rapid handoffs are used to maintain the wireless communications coverage and/or connectivity, such as UEs in or on high-speed trains or vehicles.

In some aspects, the pre-SSB FMCW-based PSS design described previously may support multiple cells with SFN transmissions. For example, the pre-SSB FMCW-based PSS design may support three, four, eight, or 16 cells. In some aspects, the amount of cells supported by the pre-SSB FMCW-based PSS design may depend on whether pre-SSB FMCW-based PSSs can be detected in non-nearest neighboring network entities or cells. Additionally, the pre-SSB FMCW-based PSSs may or may not be used for cell discovery use cases and may be used for other use cases, such as tracking (e.g., location or positioning tracking of UEs) and/or radio resource management (RRM) (e.g., to improve radio resource or channel utilization, mitigate interference, improve quality of service (QoS) performance, etc.).

The techniques and apparatuses described herein provide a technical solution for FMCW designs to support multiple cells with SFN transmissions. For example, multiple FMCW-based synchronization signals may be sent via respective cells, where each FMCW-based synchronization signal of the multiple FMCW-based synchronization signals differ in time duration, frequency range, and/or phase coding. In some aspects, the differences in time duration, frequency range, and/or phase coding may be used to modulate physical-layer identities (e.g., N_{ID}⁽²⁾ described previously) for each cell. Subsequently, a UE may identify the physical-layer identities for each cell based on the differences in time duration, frequency range, and/or phase coding between the multiple FMCW-based synchronization signals. Accordingly, the UE may then monitor for an SSB from one of the cells based on identifying the physical-layer identity for that cell from the multiple FMCW-based synchronization signals. For example, the UE may select a cell from the multiple cells based on signal strength and/or signal quality measurements from the multiple FMCW-based synchronization signals (e.g., which cell of the multiple cells has a higher signal strength and/or signal quality measurement), where a physical-layer identity for that cell is determined as described above for the UE to then monitor for an SSB from that cell.

In some aspects, the multiple FMCW-based synchronization signals may include X-shaped FMCW-based synchronization signals and/or V-shaped FMCW-based synchronization signals as described previously. In one example, a respective X-shaped FMCW-based synchronization signal may be used for each cell. For example, a first synchronization signal sent via a first cell may include an X-shaped FMCW waveform (e.g., a first FMCW waveform) that includes a first FMCW signal with a first slope and a second FMCW signal with a second slope, where the first slope and the second slope form a first “X.” Subsequently, a second synchronization signal sent via a second cell may include an additional FMCW waveform (e.g., a second FMCW waveform) that includes a third FMCW signal that is generated with a same slope as either the first FMCW signal (e.g., the first slope) or the second FMCW signal (e.g., the second slope). Additionally, the additional FMCW waveform may be sent in a same time and frequency (time-frequency) resource that is used for sending the X-shaped FMCW waveform. In some aspects, the third FMCW signal of the additional FMCW waveform may intersect with either the first FMCW signal or the second FMCW signal to form a second “X” in the same time-frequency resource as the first “X.” Additionally or alternatively, the second synchronization signal may include both the X-shaped FMCW waveform and the additional FMCW waveform, such that the second synchronization signal includes the first FMCW signal, the second FMCW signal, and the third FMCW signal.

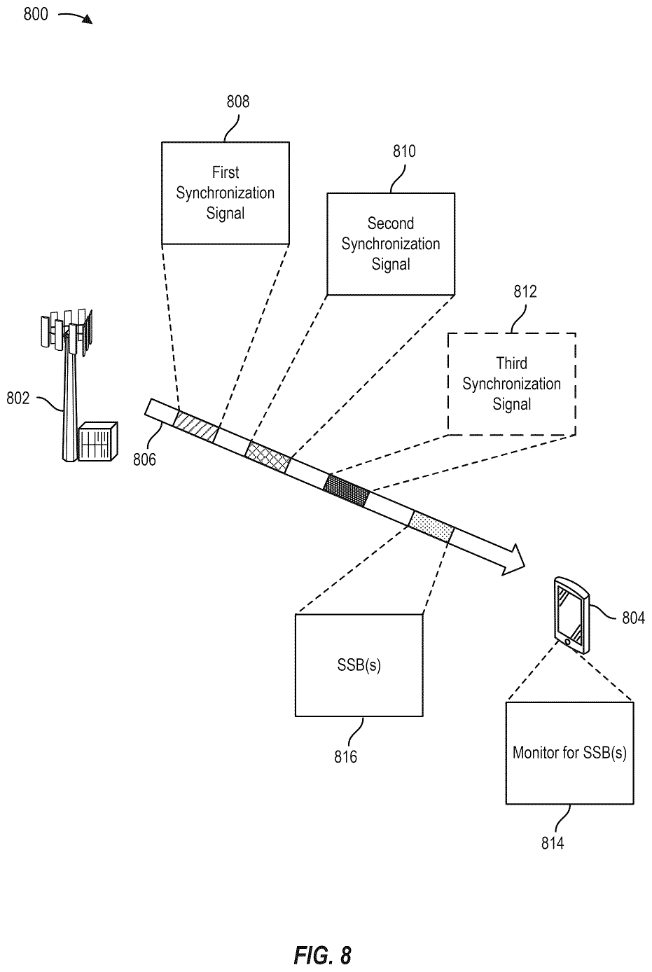

Accordingly, the X-shaped FMCW waveform and the additional FMCW waveform may be used as a “watermark” to indicate (e.g., modulate) the physical-layer identities of the first cell and the second cell. Additionally or alternatively, a time difference between the X-shaped FMCW waveform and the additional FMCW waveform may be used to further modulate the physical-layer identities of the first cell and the second cell. In some aspects, multiple time differences may be used to boost a multiplexing capability of multiple FMCW waveforms to support more cell IDs (e.g., for a third cell, fourth cell, etc.). The multiple X-shaped FMCW waveforms and time differences are described in greater detail with respect to FIG. 8.

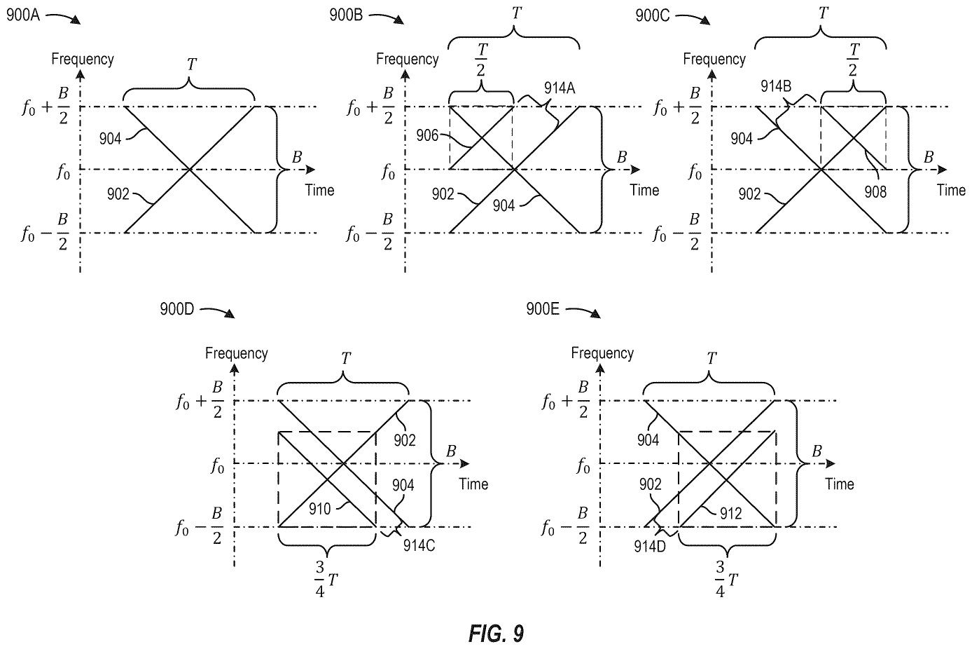

Additionally or alternatively, a phase coding difference between the X-shaped FMCW waveform and the additional FMCW waveform may be used to indicate (e.g., modulate) the physical-layer identities of the first cell and the second cell. That is, the first FMCW signal and/or the second FMCW signal may be sent with a first phase and/or first phase coding, and the third FMCW signal may be sent with a second phase and/or second phase coding. Accordingly, a differential phase between the first phase and/or first phase coding and the second phase and/or second phase coding may be used to further modulate the physical-layer identities of the first cell and the second cell. In some aspects, the differential phases and/or differential phase coding may be used to support a higher number of cells (e.g., more than three or four cells). The multiple X-shaped FMCW waveforms and phase/phase coding differences are described in greater detail with respect to FIG. 9.

Additionally or alternatively, the multiple FMCW-based synchronization signals may include at least one V-shaped FMCW waveform. For example, rather than an X-shaped FMCW waveform, the first synchronization signal sent via the first cell may include a V-shaped FMCW waveform, where the first FMCW signal and the second FMCW signal form a “V.” Subsequently, the third FMCW signal of the additional FMCW waveform (e.g., for the second synchronization signal) may intersect with either the first FMCW signal or the second FMCW signal to form a “X” in the same time-frequency resource used to send the V-shaped FMCW waveform. Additionally or alternatively, the second synchronization signal may include both the V-shaped FMCW waveform and the additional FMCW waveform, such that the second synchronization signal includes the first FMCW signal, the second FMCW signal, and the third FMCW signal.

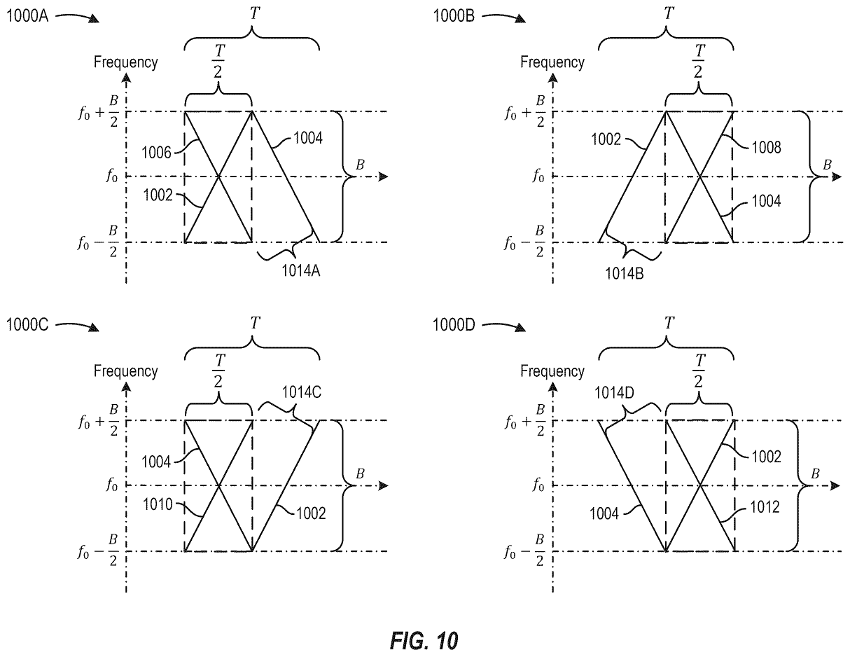

Accordingly, the V-shaped FMCW waveform and the additional FMCW waveform may be used as a watermark to modulate the physical-layer identities of the first cell and the second cell. Additionally or alternatively, a phase coding difference between the V-shaped FMCW waveform and the additional FMCW waveform may be used to modulate the physical-layer identities of the first cell and the second cell as described previously. In some aspects, the V-shaped FMCW waveform may be used for modulating physical-layer identities of more than two cells (e.g., using the phase coding differences). The V-shaped FMCW waveform with the additional FMCW waveform is described in greater detail with respect to FIG. 10.

After receiving the first synchronization signal and the second synchronization signal (e.g., and optionally any additional synchronization signals), the UE may then monitor for an SSB from one of the cells based on identifying the physical-layer identity for that cell from the multiple FMCW waveforms to assist in establishing a connection with one of the cells. In some aspects, the intersections of the different FMCW signals described above may correspond to respective frequencies, and the SSBs from each cell may be sent according to the respective frequencies.

In certain aspects, the techniques for using FMCW designs to support multiple cells (e.g., with SFN transmissions) as described herein may provide any of various beneficial effects and/or advantages. For example, respective synchronization signals from the multiple cells may be sent using the FMCW designs to enhance wireless communications coverage for a UE. That is, the UE may identify which synchronization signal is sent via a corresponding cell and may also identify a physical-layer identity for a given cell using the FMCW designs, such that the UE can then establish and/or transfer its communications to that cell to maintain connectivity. Additionally, the FMCW designs proposed herein may allow relative low complexity receiver-side circuitry to perform wideband channel estimation, which may help keep cost down while still providing accurate channel estimation and improved performance.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

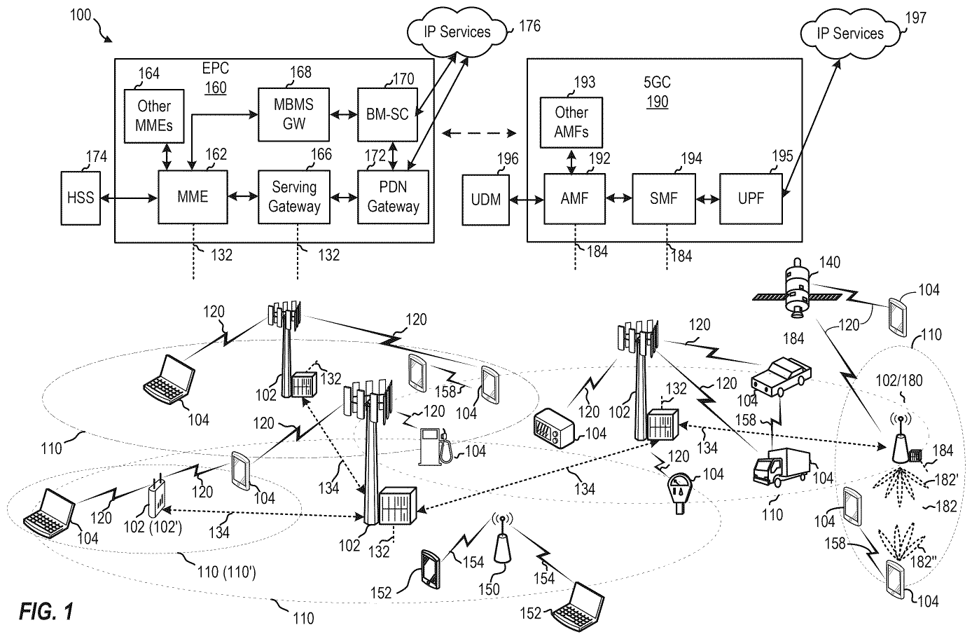

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

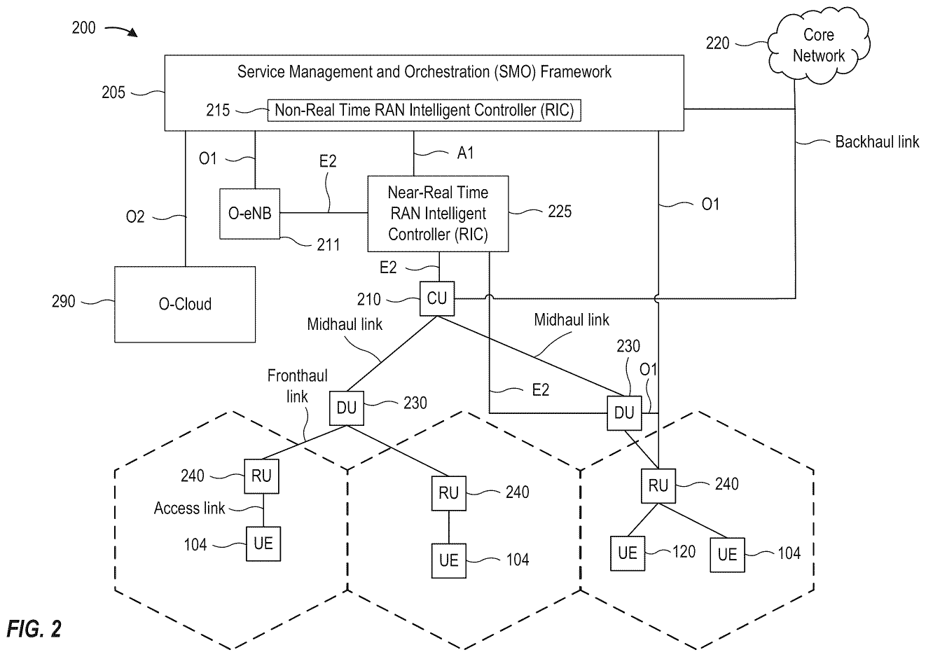

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mm W” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

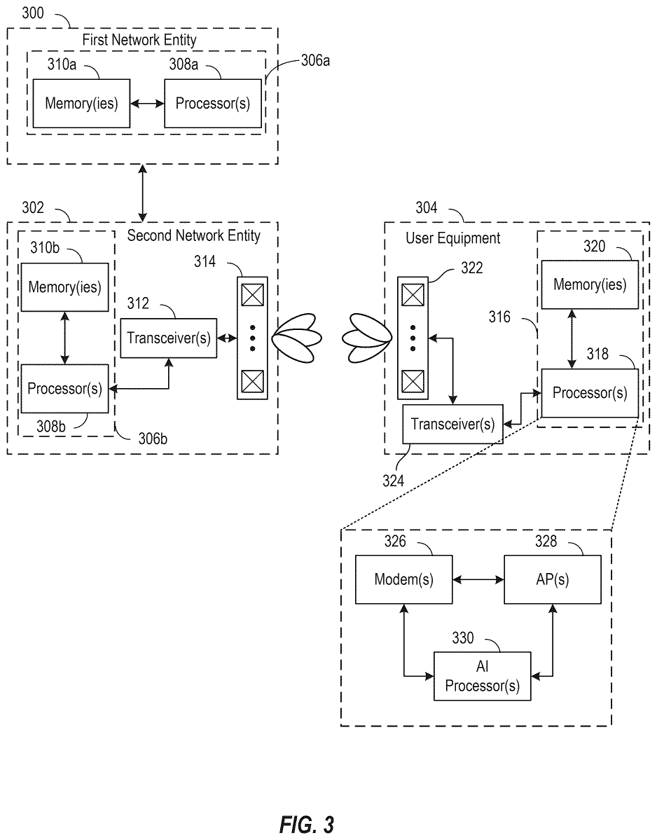

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

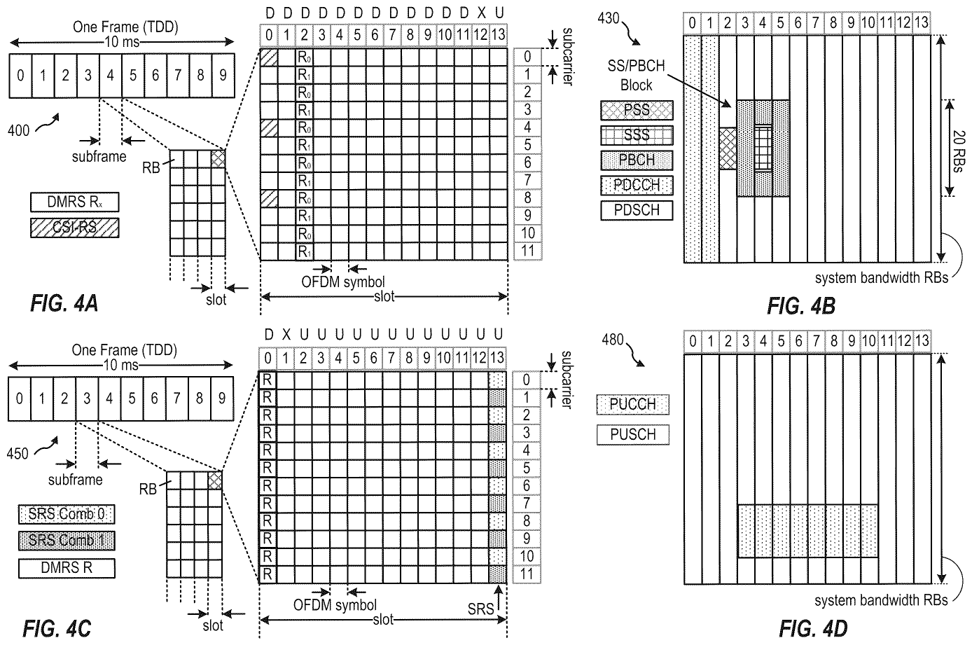

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to FMCW-Based Synchronization Signals

FIG. 5A depicts an example FMCW-based synchronization signal 500 sent at a transmitter side (e.g., by a network entity and/or via a given cell). In some aspects, the FMCW-based synchronization signal 500 may represent an example of an X-shaped FMCW synchronization signal design according to some aspects. For example, instead of a single FMCW waveform and/or single FMCW signal, the FMCW-based synchronization signal 500 may use an overlaying of two FMCW signals to serve as a synchronization signal (e.g., PSS). As illustrated in the FMCW-based synchronization signal 500 of FIG. 5A, an X-shaped FMCW-based PSS may be formed using a first FMCW signal 506 with an associated frequency that increases (ramps up from

$${f}_{0} - \frac{B}{2} to {f}_{0} + \frac{B}{2} )$$

linearly in time (over a period T) and a second FMCW signal 508 with an associated frequency that decreases (ramps down from

$${f}_{0} + \frac{B}{2} to {f}_{0} - \frac{B}{2} )$$

linearly in time (over T). Thus, the first FMCW signal 506 has a slope of B/T, while the second FMCW signal 508 has a slope of −B/T.

As illustrated, by using the same up-sweep ramp and down-sweep ramp, the first FMCW signal 506 and second FMCW signal 508 form an X shape. A center of the X shape may be defined as f₀, a sync raster point for a corresponding synchronization signal (e.g., PSS) formed thereby. In some cases, an OFDM architecture may be used to generate the FMCW signal(s) that for the PSS.

As illustrated in FIG. 5A, the first and second FMCW signals may be swept up/down a frequency of band B over a time duration of T. In some aspects, the time duration of T may be one OFDM symbol. The receiver may also perform timing offset estimation (e.g., based on the beat frequency of the first FMCW signal and the beat frequency of the second FMCW signal, B, and T).

FIG. 5B depicts an example FMCW-based synchronization signal 502 obtained at a receiver side (e.g., UE). In some aspects, the FMCW-based synchronization signal 502 may represent an example of an X-shaped FMCW synchronization signal design according to some aspects. While the transmitted FMCW signals (for a particular PSS candidate) may be swept over a frequency of band B for a time duration of T, the receiver does not know the timing and frequency information. Therefore, the receiver may search for PSS candidates over a larger resource grid. For example, as illustrated in FMCW-based synchronization signal 502 of FIG. 5B, a receiver may search over a larger frequency band of B*L/T

$$( from {f}_{0} - \frac{B L}{2 T} to {f}_{0} + \frac{B L}{2 T} )$$

and a time duration of L (where L>T). The receiver may search over two parallel paths 510 and 512, with one ramping up and one ramping down, but both with a slope of B/T. In some aspects, the parameters may be relaxed, for example, such that the parallel paths may not (both) be centered at f₀. A receiver (e.g., a UE) may be able to search multiple sync raster points at the same time. The waveforms also do not necessarily need to be symmetric (e.g., the waveforms may have different slope absolute values).

FIG. 5C depicts an example of receiver-side processing 504 of an FMCW waveform. As illustrated in the diagram of the receiver-side processing 504 of FIG. 5C, for a relatively simple low-complexity receiver (e.g., at a UE) to receive the X-shaped FMCW-based SS proposed herein, two VCO paths could be used. A first VCO path will use a first VCO 514 generate an up-sweep FMCW to combine with the received signal. A second VCO path will use a second VCO 520 to generate a down-sweep FMCW to combine with the received signal. Each VCO path generates a mixer output (after LPFs 516 and 522) that combines the two FMCW detector outputs for detection (via an ADC 518).

FIGS. 6A and 6B depict an example of FMCW detector output processing at a receiver side (e.g., UE). Diagram 600 of FIG. 6A shows the transmitted FMCW signals (606 and 608) and the local FMCW signals (602 and 604). As illustrated in diagram 610 of FIG. 6B, the combined mixed signal will have two beat frequencies (616 and 618), corresponding to two peaks in the beat frequency domain. The receiver can ignore other signals 612 and 614 (e.g., corresponding to regions outside period T over which the FMCW signals are transmitted). The receiver may perform frequency offset estimation as follows. The frequency offset between the transmitter (TX) and receiver (RX) (e.g., the beat frequency) will be reflected in asymmetric tone locations of the two FMCW branches. These two beat frequencies may be denoted as fₓ and f_{y}, while the frequency offset may be denoted as Δ_{f}. The transmitter and receiver (TX/RX) frequency offset is calculated as

$${Δ}_{f} = \frac{{f}_{x} - {f}_{y}}{2} .$$

FIG. 7 depicts example FMCW-based synchronization signals 700. In some aspects, the FMCW-based synchronization signals 700 may represent examples of V-shaped FMCW synchronization signal designs according to some aspects. The V-shaped FMCW design maintains the PAPR of 0 dB and increases the SNR in comparison to the X-shaped FMCW designs shown in FIGS. 5A-6B. The V-shaped FMCW design includes an FMCW waveform (e.g., FMCW waveform 700A) including a first FMCW signal 702 (e.g., a down or down-sweep FMCW signal) having a linearly decreasing slope and a second FMCW signal 704 (e.g., an up or up-sweep FMCW signal) having a linearly increasing slope. For example, the first FMCW signal 702 has an associated frequency that decreases (ramps down) linearly in time, and the second FMCW signal 704 has an associated frequency that increases (ramps up) linearly in time. The first FMCW signal 702 may be concatenated in time with the second FMCW signal 704. In some examples, the V-shaped FMCW design may use an OFDM architecture to generate the FMCW waveform (e.g., FMCW waveform 700A).

In some examples, as shown in FIG. 7, each of the first FMCW signal 702 and the second FMCW signal 704 may have a same bandwidth (B) with a center frequency f₀ corresponding to a sync raster point for a corresponding synchronization signal (e.g., PSS) formed thereby. For example, the first FMCW signal 702 may down-sweep from

$${f}_{0} + \frac{B}{2} to {f}_{0} - \frac{B}{2} ,$$

and the second FMCW signal 704 may up-sweep from

$${f}_{0} - \frac{B}{2} to {f}_{0} + \frac{B}{2} .$$

In some examples, as indicated by the FMCW waveform 700A, the down-sweep ramp of the first FMCW signal 702 may be the same as the up-sweep ramp of the second FMCW signal 704. Thus, each of the first FMCW signal 702 and the second FMCW signal 704 may have not only the same bandwidth (B), but also the same time-sweeping duration and the same absolute value of slope. For example, the total time duration for down-sweeping and up-sweeping may be represented as T, with each of the down-sweep time duration and the up-sweep time duration corresponding to T/2. Additionally, the absolute value of the slope of each of the first FMCW signal 702 and second FMCW signal 704 may be B/(T/2). For example, the slope of the first FMCW signal 702 may be −B/(T/2), and the slope of the second FMCW signal 704 may be B/(T/2)). In some examples, the total time duration (T) may correspond to one OFDM symbol length.

In the FMCW waveform 700A, the V-shaped FMCW waveform includes the first FMCW signal 702 (e.g., the down or down-sweep FMCW signal) followed by the second FMCW signal 704 (e.g., the up or up-sweep FMCW signal), where the second FMCW signal 704 is concatenated in time with the first FMCW signal 702. In other examples, an inverse V-shaped FMCW waveform (e.g., FMCW waveform 700B) may be generated using the second FMCW signal 704 (e.g., an up or up-sweep FMCW signal) followed by the first FMCW signal 702 (e.g., a down or down-sweep FMCW signal), where the first FMCW signal 702 is concatenated in time with the second FMCW signal 704. As indicated by the inverse V-shaped FMCW waveform 700B, the up-sweep ramp of the second FMCW signal 704 may be the same as the down-sweep ramp of the first FMCW signal 702. Thus, the second FMCW signal 704 may have the same bandwidth (B) and time duration (T/2) as the first FMCW signal 702. For example, the total time duration (T) may correspond to one OFDM symbol length, with each of the second FMCW signal 704 and the first FMCW signal 702 having a time duration of ½ OFDM symbol length. Thus, each of the second FMCW signal 704 and the first FMCW signal 702 may have the same absolute slope value.

In other examples, the down-sweep ramp of the first FMCW signal 702 may be different than the up-sweep ramp of the second FMCW signal 704. The bandwidth (B) remains the same between the first FMCW signal 702 and the second FMCW signal 704. However, the time-sweeping duration differs between the first FMCW signal 702 and the second FMCW signal 704, and as a result, the absolute values of the slopes of each of the first FMCW signal 702 and the second FMCW signal 704 differ from one another.

### Aspects Related to FMCW-Based Synchronization Signals for Multiple Cells

FIG. 8 depicts an example wireless communications network 800 that supports FMCW-based synchronization signals for multiple cells in accordance with aspects of the present disclosure. In some examples, the wireless communications network 800 may implement aspects of or may be implemented by aspects of FIGS. 1-7. For example, the wireless communications network 800 may include a network entity 802 and a UE 804. In some aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. Additionally, the wireless communications network 800 may be an example of wireless communications network 100 and may support communication between the network entity 802 and the UE 804. For example, the network entity 802 and the UE 804 may wirelessly communicate via a communication link 806 (e.g., a downlink communication link, one or more carriers, a communication link 120, etc.).

The wireless communications network 800 may employ FMCW designs to support multiple cells with SFN transmission. For example, with a same time-frequency resource, an additional FMCW waveform may be introduced in an X-shaped FMCW-waveform-based pre-SSB synchronization signal as a watermark to modulate physical-layer identities of one or more cells. In some aspects, modulating the physical-layer identities of the one or more cells using the FMCW designs described herein may achieve a similar functionality as determination or indication of N_{ID}⁽²⁾ from other synchronization signals (e.g., NR PSSs). The additional FMCW waveform may be transmitted within the same time-frequency resource used to communicate the X-shaped FMCW waveform without causing interference.

To lower complexity of the UE 804, the additional FMCW waveform may be generated with a same slope as one of the FMCW signals for the X-shaped FMCW waveform. Additionally, a time difference between the X-shaped FMCW waveform and the additional FMCW waveform (e.g., a difference of configured time durations between the X-shaped FMCW waveform and the additional FMCW waveform) may be used to further modulate the physical-layer identities of the one or more cells. In some aspects, differential phase coding between the X-shaped FMCW waveform and the additional FMCW waveform may be used to modulate the physical-layer identities of the one or more cells. For example, for some use cases of supporting more than three or four cells, the differential phase coding between the X-shaped FMCW waveform and the additional FMCW waveform may be used to modulate the physical-layer identities of the one or more cells. The X-shaped FMCW waveform and the additional FMCW are depicted and described in greater detail with respect to FIG. 9.

In some aspects, the FMCW designs for supporting multiple cells with SFN transmissions may include V-shaped FMCW waveform designs. For example, with a same time-frequency resource, an additional FMCW waveform may be introduced to formulate an X-shaped FMCW waveform in a V-shaped FMCW-waveform-based pre-SSB synchronization signal as a “watermark” to modulate physical-layer identities of one or more cells. Additionally, for some use cases of supporting more than three or four cells, differential phase coding in the hybrid V-shaped FMCW waveform and the X-shaped FMCW waveform may be used to modulate the physical-layer identities of the one or more cells. The hybrid V-shaped FMCW waveform and the X-shaped FMCW waveform is depicted and described in greater detail with respect to FIG. 10.

In the example of FIG. 8, the UE 804 may obtain, via a first cell (e.g., from the network entity 802, such as via the communication link 806), a first synchronization signal 808 that includes a first FMCW waveform. In some aspects, the first FMCW waveform may include a first FMCW signal with a first slope that linearly increases in time and a second FMCW signal with a second slope that linearly decreases in time. For example, the first FMCW waveform may include an X-shaped FMCW waveform (e.g., as depicted and described with respect to FIGS. 5A-6B) or a V-shaped FMCW waveform (e.g., as depicted and described with respect to FIG. 7).

The UE 804 may also obtain, via at least a second cell (e.g., from the network entity 802, such as via the communication link 806, or from a different network entity), at least one second synchronization signal 810 that includes a second FMCW waveform. In some aspects, the second FMCW waveform may at least include a third FMCW signal with the first slope or the second slope. Additionally, the at least one second synchronization signal 810 may include the first FMCW waveform and the second FMCW waveform.

In some aspects, the UE 804 may obtain the first synchronization signal 808 and the at least one second synchronization signal 810 in a same time-frequency resource. Additionally, the first FMCW waveform and the second FMCW waveform may include an SFN transmission as described previously. For example, a first network entity may send the first FMCW waveform as part of the SFN transmission, and a second network entity may send the second FMCW waveform as part of the SFN transmission.

In some aspects, the first synchronization signal 808 and/or the first FMCW waveform may be used to modulate a first physical-layer identity corresponding to the first cell, and the at least one second synchronization signal 810 and/or the second FMCW waveform may be used to modulate a second physical-layer identity corresponding to the second cell. Additionally or alternatively, a time difference between the first FMCW waveform and the second FMCW waveform may be used to modulate the second physical-layer identity corresponding to the second cell. For example, the first FMCW waveform may have a first duration, and the second FMCW waveform may have a second duration, where the second duration is less than the first duration. Accordingly, a time difference between the first duration and the second duration may indicate the second physical-layer identity corresponding to the second cell.

Additionally or alternatively, a differential phase between the third FMCW signal of the second FMCW waveform and either the first FMCW signal or the second FMCW signal of the first FMCW waveform may be used to modulate the second physical-layer identity corresponding to the second cell. For example, when the third FMCW signal has the first slope (e.g., a same slope value as the first FMCW signal), the first FMCW signal may have a first phase, and the third FMCW signal may have a second phase. Accordingly, a differential phase between the first phase and the second phase may indicate a physical-layer identity corresponding to the second cell. Additionally or alternatively, when the third FMCW signal has the second slope (e.g., a same slope value as the second FMCW signal), the second FMCW signal may have a first phase, and the third FMCW signal may have a second phase. Accordingly, a differential phase between the first phase and the second phase may indicate a physical-layer identity corresponding to the second cell.

In some aspects, the first FMCW waveform may span a first frequency range, and the second FMCW waveform may span a second frequency range. In some aspects, the second frequency range may be smaller than the first frequency range (e.g., as depicted and described in greater detail with respect to FIG. 9). Additionally or alternatively, the first frequency range may be the same as the second frequency range (e.g., as depicted and described in greater detail with respect to FIG. 10).

In some aspects, the FMCW designs for supporting multiple cells with SFN transmissions may be used for more than two cells. For example, the UE 804 may obtain, via a third cell (e.g., from the network entity 802, such as via the communication link 806, and/or from a different network entity), a third synchronization signal 812 that includes a third FMCW waveform. In some aspects, the third FMCW waveform may include a fourth FMCW signal with the first slope or the second slope. Additionally, the UE 804 may obtain the third synchronization signal 812 in a same time-frequency resource as the first synchronization signal 808 and the at least one second synchronization signal 810. In some aspects, the third FMCW waveform may be part of the same SFN transmission with the first FMCW waveform and the second FMCW waveform. In some aspects, the third synchronization signal 812 may be used to modulate a third physical-layer identity corresponding to the third cell.

The first FMCW waveform may have the first duration, and the third FMCW waveform may have a third duration, where the third duration is less than the first duration. Accordingly, a time difference between the first duration and the third duration may be used to modulate the third physical-layer identity corresponding to the third cell. Additionally or alternatively, when the fourth FMCW signal has the first slope (e.g., a same slope value as the first FMCW signal) and the first FMCW signal has the first phase, the fourth FMCW signal may have a third phase. Accordingly, a differential phase between the first phase and the third phase may be used to modulate the third physical-layer identity corresponding to the third cell. Additionally or alternatively, when the fourth FMCW signal has the second slope (e.g., a same slope value as the second FMCW signal) and the second FMCW signal has the first phase, differential phase between the first phase and the third phase may be used to modulate the third physical-layer identity corresponding to the third cell.

After receiving the different synchronization signals, the UE 804 may perform monitoring 814 for a first SSB corresponding to the first cell or a second SSB corresponding to the second cell based on the first synchronization signal 808 and/or the at least one second synchronization signal 810. In some aspects, the first FMCW signal and the second FMCW signal may intersect at a first frequency, and the third FMCW signal may intersect the first FMCW signal or the second FMCW signal (e.g., depending on whether the third FMCW signal has the second slope or the first slope, respectively) at a second frequency. Subsequently, the UE 804 may perform the monitoring 814 to monitor for the first SSB at the first frequency and/or to monitor for the second SSB at the second frequency. Additionally or alternatively, the UE 804 may perform the monitoring 814 to monitor for a third SSB corresponding to the third cell based on the third synchronization signal 812. For example, the fourth FMCW signal may intersect the first FMCW signal or the second FMCW signal (e.g., depending on whether the third FMCW signal has the second slope or the first slope, respectively) at a third frequency. Subsequently, the UE 804 may perform the monitoring 814 to monitor for the third SSB at the third frequency.

In some aspects, the network entity 802 may send (e.g., broadcast) one or more SSBs 816. For example, the network entity 802 may send the first SSB corresponding to the first cell based on the first synchronization signal 808 and/or the second SSB corresponding to the second cell based on the at least one second synchronization signal 810. In some aspects, the network entity 802 may send the first SSB at the first frequency and/or may send the second SSB at the second frequency. Additionally, the network entity 802 may send a third SSB corresponding to the third cell based on the third synchronization signal 812. For example, the network entity 802 may send the third SSB at the third frequency. Additionally or alternatively, respective network entities may send each SSB.

FIG. 9 depicts example FMCW-based synchronization signals in accordance with aspects of the present disclosure. In some examples, the FMCW-based synchronization signals of FIG. 9 may implement aspects of or may be implemented by aspects of FIGS. 1-8. For example, a UE, such as the UE 804 depicted and described with respect to FIG. 8, may obtain the FMCW-based synchronization signals via one or more cells. For example, the UE may obtain a first synchronization signal (e.g., the first synchronization signal 808 as described with respect to FIG. 8) that includes a first FMCW waveform. The first FMCW waveform may include a first FMCW signal 902 with a first slope that linearly increases in time and a second FMCW signal 904 with a second slope that linearly decreases in time. The first FMCW waveform may be represented by an example FMCW-based synchronization signal 900A. For example, the first FMCW signal 902 and the second FMCW signal 904 may have a bandwidth (B) and may form a first “X” (e.g., as depicted and described with respect to FIGS. 5A-6B), where the first FMCW signal 902 and the second FMCW signal 904 intersect at f₀.

The UE may also obtain a second synchronization signal (e.g., the first synchronization signal 808 as described with respect to FIG. 8) that includes a second FMCW waveform. In some aspects, the first synchronization signal may be used to modulate a first physical-layer identity corresponding to the first cell, and the second synchronization signal may be used to modulate a second physical-layer identity corresponding to the second cell. Additionally, the second FMCW waveform may include at least an additional FMCW signal. For example, the UE may obtain an additional FMCW signal 906 as depicted in example FMCW-based synchronization signals 900B, an additional FMCW signal 908 as depicted in example FMCW-based synchronization signals 900C, an additional FMCW signal 910 as depicted in example FMCW-based synchronization signals 900D, or an additional FMCW signal 912 as depicted in example FMCW-based synchronization signals 900E. The additional FMCW signal 906 and the additional FMCW signal 912 may have the first slope, and the additional FMCW signal 908 and the additional FMCW signal 910 may have the second slope.

Each additional FMCW signal may form a second “X” with either the first FMCW signal 902 or the second FMCW signal 904. For example, the additional FMCW signal 906 may form the second “X” with the second FMCW signal 904, the additional FMCW signal 908 may form the second “X” with the first FMCW signal 902, the additional FMCW signal 910 may form the second “X” with the first FMCW signal 902, and the additional FMCW signal 912 may form the second “X” with the second FMCW signal 904.

In some aspects, a first duration of the first FMCW waveform may be different than a second duration of the second FMCW waveform, where the second duration is less than the first duration. For example, the first duration of the first FMCW waveform may be equal to T. In some aspects, for the additional FMCW signal 906 and the additional FMCW signal 908, the second duration of the corresponding second FMCW waveform may be equal to T/2. Accordingly, in such aspects, a time difference between the first duration and the second duration may be equal to T/2. Additionally or alternatively, in other aspects, for the additional FMCW signal 910 and the additional FMCW signal 912, the second duration of the corresponding second FMCW waveform may be equal to ¾*T. Accordingly, in such aspects, a time difference between the first duration and the second duration may be equal to ¼*T.

Subsequently, the time difference between the first duration and the second duration of the second FMCW waveform may indicate a physical-layer identity corresponding to different cells (e.g., N_{ID}⁽²⁾ as described previously). For example, if three cells are available for communication, the example FMCW-based synchronization signal 900A may correspond to N_{ID}⁽²⁾=0, the example FMCW-based synchronization signals 900B may correspond to N_{ID}⁽²⁾=1, and the example FMCW-based synchronization signals 900C may correspond to N_{ID}⁽²⁾=2. Accordingly, the UE may determine these physical-layer identities based on the respective additional FMCW signals and/or time differences.

Additionally or alternatively, if four cells are available for communication, the example FMCW-based synchronization signals 900B may correspond to N_{ID}⁽²⁾=0, the example FMCW-based synchronization signals 900C may correspond to N_{ID}⁽²⁾=1, and the example FMCW-based synchronization signals 900D may correspond to N_{ID}⁽²⁾=2, and the example FMCW-based synchronization signals 900E may correspond to N_{ID}⁽²⁾=3. Accordingly, the UE may determine these physical-layer identities based on the respective additional FMCW signals and/or time differences. In some aspects, other time differences may be used than T/2 or ¼*T. For example, multiple time differences may be used to boost a multiplexing capability to support a higher number of cell identifiers.

In some aspects, differential phases 914 (84) (e.g., differential phase codings) may be used to indicate a physical-layer identity corresponding to different cells. The brackets indicated by reference number 914 are intended to indicate the two signals associated with the differential phase, not to illustrate the differential phase itself. A first phase (φ₁) may be used for either the first FMCW signal 902 and/or the second FMCW signal 904, and a second phase (φ₂) may be used for the respective additional FMCW signals. In the example of FIG. 9, a first differential phase 914A may exist between the additional FMCW signal 906 and the first FMCW signal 902, a second differential phase 914B may exist between the additional FMCW signal 908 and the second FMCW signal 904, a third differential phase 914C may exist between the additional FMCW signal 910 and the second FMCW signal 904, and a fourth differential phase 914D may exist between the additional FMCW signal 912 and the first FMCW signal 902.

Accordingly, the differential phase (e.g., δ_{φ}=φ₁−φ₂) may be used to modulate a physical-layer identity of a corresponding cell. For example, if the first differential phase 914A is equal to 0, the example FMCW-based synchronization signals 900B may correspond to N_{ID}⁽²⁾=0; if the second differential phase 914B is equal to 0, the example FMCW-based synchronization signals 900C may correspond to N_{ID}⁽²⁾=1; if the third differential phase 914C is equal to 0, the example FMCW-based synchronization signals 900D may correspond to N_{ID}⁽²⁾=2; if the fourth differential phase 914D is equal to 0, the example FMCW-based synchronization signals 900E may correspond to N_{ID}⁽²⁾=3; if the first differential phase 914A is equal to π, the example FMCW-based synchronization signals 900B may correspond to N_{ID}⁽²⁾=4; if the second differential phase 914B is equal to π, the example FMCW-based synchronization signals 900C may correspond to N_{ID}⁽²⁾=5; if the third differential phase 914C is equal to π, the example FMCW-based synchronization signals 900D may correspond to N_{ID}⁽²⁾=6; and if the fourth differential phase 914D is equal to π, the example FMCW-based synchronization signals 900E may correspond to N_{ID}⁽²⁾=7. As such, using the differential phases, eight different physical-layer identities of corresponding cells may be indicated. Other differential phase values may be used than 0 or π.

FIG. 10 depicts example FMCW-based synchronization signals. In some examples, the FMCW-based synchronization signals of FIG. 10 may implement aspects of or may be implemented by aspects of FIGS. 1-8. For example, a UE, such as the UE 804 depicted and described with respect to FIG. 8, may obtain the FMCW-based synchronization signals via one or more cells. For example, the UE may obtain a first synchronization signal (e.g., the first synchronization signal 808 as described with respect to FIG. 8) that includes a first FMCW waveform. Additionally, the first FMCW waveform may include a first FMCW signal 1002 with a first slope that linearly increases in time and a second FMCW signal 1004 with a second slope that linearly decreases in time. In the example of FIG. 10, the first FMCW signal 1002 and the second FMCW signal 1004 may form a V shape or an inverted V shape (e.g., as depicted and described with respect to FIG. 7). For example, example FMCW-based synchronization signals 1000A and 1000B may represent an inverted V shape for the first FMCW waveform, and example FMCW-based synchronization signals 1000C and 1000D may represent a V shape for the first FMCW waveform. In each of the example FMCW-based synchronization signals 1000A, 1000B, 1000C, and 1000D, the first FMCW waveform may have a same bandwidth (B) with a center frequency f₀.

The UE may also obtain a second synchronization signal (e.g., the first synchronization signal 808 as described with respect to FIG. 8) that includes a second FMCW waveform. In some aspects, the second FMCW waveform may include at least an additional FMCW signal. For example, the UE may obtain an additional FMCW signal 1006 as depicted in example FMCW-based synchronization signals 1000A, an additional FMCW signal 1008 as depicted in example FMCW-based synchronization signals 1000B, an additional FMCW signal 1010 as depicted in example FMCW-based synchronization signals 1000C, or an additional FMCW signal 1012 as depicted in example FMCW-based synchronization signals 1000D. The additional FMCW signal 1008 and the additional FMCW signal 1010 may have the first slope, and the additional FMCW signal 1006 and the additional FMCW signal 1012 may have the second slope.

Each additional FMCW signal may form an “X” with either the first FMCW signal 1002 or the second FMCW signal 1004. For example, the additional FMCW signal 1006 may form the “X” with the first FMCW signal 1002, the additional FMCW signal 1008 may form the “X” with the second FMCW signal 1004, the additional FMCW signal 1010 may form the “X” with the second FMCW signal 1004, and the additional FMCW signal 1012 may form the “X” with the first FMCW signal 1002.

In some aspects, the first synchronization signal may be used to modulate a first physical-layer identity corresponding to the first cell, and the second synchronization signal may be used to modulate a second physical-layer identity corresponding to the second cell. For example, if four cells are available for communication, the example FMCW-based synchronization signals 1000A may correspond to N_{ID}⁽²⁾=0, the example FMCW-based synchronization signals 1000B may correspond to N_{ID}⁽²⁾=1, and the example FMCW-based synchronization signals 1000C may correspond to N_{ID}⁽²⁾=2, and the example FMCW-based synchronization signals 1000D may correspond to N_{ID}⁽²⁾=3. Accordingly, the UE may determine these physical-layer identities based on the respective additional FMCW signals.

In some aspects, differential phases 1014 (84) (e.g., differential phase codings) may be used to indicate a physical-layer identity corresponding to different cells. The brackets indicated by reference number 1014 are intended to indicate the two signals associated with the differential phase, not to illustrate the differential phase itself. For example, a first phase (φ₁) may be denoted for either the first FMCW signal 1002 and/or the second FMCW signal 1004, and a second phase (φ₂) may be denoted for the respective additional FMCW signals. In the example of FIG. 10, a first differential phase 1014A may exist between the additional FMCW signal 1006 and the second FMCW signal 1004, a second differential phase 1014B may exist between the additional FMCW signal 1008 and the first FMCW signal 1002, a third differential phase 1014C may exist between the additional FMCW signal 1010 and the first FMCW signal 1002, and a fourth differential phase 1014D may exist between the additional FMCW signal 1012 and the second FMCW signal 1004.

Accordingly, the differential phase (e.g., δ_{φ}=φ₁−φ₂) may be used to modulate a physical-layer identity of a corresponding cell. For example, if the first differential phase 1014A is equal to 0, the example FMCW-based synchronization signals 1000A may correspond to N_{ID}⁽²⁾=0; if the second differential phase 1014B is equal to 0, the example FMCW-based synchronization signals 1000B may correspond to N_{ID}⁽²⁾=1; if the third differential phase 1014C is equal to 0, the example FMCW-based synchronization signals 1000C may correspond to N_{ID}⁽²⁾=2; if the fourth differential phase 1014D is equal to 0, the example FMCW-based synchronization signals 1000D may correspond to N_{ID}⁽²⁾=3; if the first differential phase 1014A is equal to π, the example FMCW-based synchronization signals 1000A may correspond to N_{ID}⁽²⁾=4; if the second differential phase 1014B is equal to π, the example FMCW-based synchronization signals 1000B may correspond to N_{ID}⁽²⁾=5; if the third differential phase 1014C is equal to π, the example FMCW-based synchronization signals 1000C may correspond to N_{ID}⁽²⁾=6; and if the fourth differential phase 1014D is equal to π, the example FMCW-based synchronization signals 1000D may correspond to N_{ID}⁽²⁾=7. As such, using the differential phases, eight different physical-layer identities of corresponding cells may be indicated. Other differential phase values may be used than 0 or π.

### Example Signaling of FMCW-Based Synchronization Signals for Multiple Cells

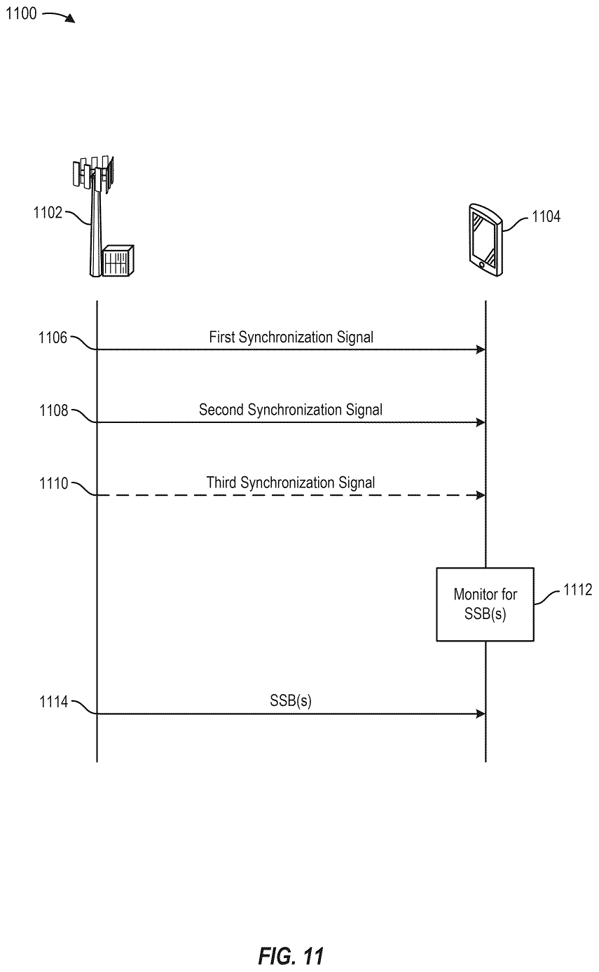

FIG. 11 depicts a process flow 1100 for communications in a network between a network entity 1102 and a UE 1104. In some aspects, the network entity 1102 may be an example of the BS 102 depicted and described with respect to FIG. 1, the first network entity 300 or the second network entity 302 depicted and described with respect to FIG. 3, a disaggregated base station depicted and described with respect to FIG. 2, or the network entity 802 depicted and described with respect to FIG. 8. Similarly, the UE 1104 may be an example of UE 104 depicted and described with respect to FIG. 1, the UE 304 depicted and described with respect to FIG. 3, or the UE 804 depicted and described with respect to FIG. 8. However, in other aspects, UE 1104 may be another type of wireless communications device and network entity 1102 may be another type of network entity or network node, such as those described herein. Note that any operations or signaling illustrated with dashed lines may indicate that that operation or signaling is an optional or alternative example.

At 1106, the UE 1104 obtains, via a first cell, a first synchronization signal (e.g., the first synchronization signal 808 as described with respect to FIG. 8) that includes a first FMCW waveform. Additionally, the first FMCW waveform may include a first FMCW signal with a first slope that linearly increases in time and a second FMCW signal with a second slope that linearly decreases in time. In some aspects, the first synchronization signal is used to modulate a first physical-layer identity corresponding to the first cell.

At 1108, the UE 1104 obtains, via at least a second cell, at least a second synchronization signal (e.g., the at least one second synchronization signal 810 as described with respect to FIG. 8) that includes a second FMCW waveform. Additionally, the second FMCW waveform may include a third FMCW signal with the first slope or the second slope. In some aspects, the UE 1104 may obtain the first synchronization signal and the at least second synchronization signal in a same time-frequency resource. Additionally, the first FMCW waveform and the second FMCW waveform may include an SFN transmission. In some aspects, the at least second synchronization signal may include the first FMCW waveform and the second FMCW waveform. In some aspects, the second synchronization signal may be used to modulate a second physical-layer identity corresponding to the second cell.

In some aspects, the first FMCW waveform may have a first duration, and the second FMCW waveform may have a second duration. For example, the second duration may be less than the first duration. Accordingly, a time difference between the first duration and the second duration may indicate a physical-layer identity corresponding to the second cell. In some aspects, the first FMCW waveform may span a first frequency range, and the second FMCW waveform may span a second frequency range. For example, the second frequency range may be smaller than the first frequency range (e.g., as depicted and described with respect to FIG. 9). Alternatively, the first frequency range may be the same as the second frequency range (e.g., as depicted and described with respect to FIG. 10).

Additionally or alternatively, in some aspects, the third FMCW signal may have the first slope. In such aspects, the first FMCW signal may have a first phase, and the third FMCW signal may have a second phase. Accordingly, a differential phase between the first phase and the second phase may indicate the second physical-layer identity corresponding to the second cell. Additionally or alternatively, in some aspects, the third FMCW signal may have the second slope. In such aspects, the second FMCW signal may have a first phase, and the third FMCW signal may have a second phase. Accordingly, a differential phase between the first phase and the second phase may indicate the second physical-layer identity corresponding to the second cell.

At 1110, the UE 1104 may optionally obtain, via a third cell, a third synchronization signal (e.g., the third synchronization signal 812 described with respect to FIG. 8) that includes a third FMCW waveform. Additionally, the third FMCW waveform may include a fourth FMCW signal with the first slope or the second slope. In some aspects, the UE 1104 may obtain the third synchronization signal in a same time-frequency resource as the first synchronization signal and the at least second synchronization signal. Additionally, the third FMCW waveform may be part of the same SFN transmission as the first FMCW waveform and the second FMCW waveform. In some aspects, the third synchronization signal includes the third FMCW waveform and the first FMCW waveform. Additionally, the third synchronization signal may be used to modulate a third physical-layer identity corresponding to the third cell.

In some aspects, the first FMCW waveform may have the first duration, and the third FMCW waveform may have a third duration. For example, the third duration may be less than the first duration. Accordingly, a time difference between the first duration and the third duration may be used to modulate the third physical-layer identity corresponding to the third cell.

Additionally or alternatively, in some aspects, the fourth FMCW signal may have the first slope. In such aspects, the first FMCW signal may have a first phase, and the fourth FMCW signal may have a third phase. Accordingly, a differential phase between the first phase and the third phase may indicate the third physical-layer identity corresponding to the third cell. Additionally or alternatively, in some aspects, the fourth FMCW signal may have the second slope. In such aspects, the second FMCW signal may have a first phase, and the fourth FMCW signal may have a third phase. Accordingly, a differential phase between the first phase and the third phase may indicate the third physical-layer identity corresponding to the third cell.

At 1112, the UE 1104 monitors (e.g., the monitoring 814 described with respect to FIG. 8) for a first SSB corresponding to the first cell based on the first synchronization signal or a second SSB corresponding to the second cell based on the at least second synchronization signal. In some aspects, the first FMCW signal and the second FMCW signal may intersect at a first frequency, and the third FMCW signal may intersects the first FMCW signal or the second FMCW signal at a second frequency. Accordingly, the UE 1104 may monitor for the first SSB at the first frequency and/or may monitor for the second SSB at the second frequency. Additionally, the UE 1104 may monitor for a third SSB corresponding to the third cell based on the third synchronization signal. For example, the fourth FMCW signal may intersect the first FMCW signal or the second FMCW signal at a third frequency, and the UE 1104 may monitor for the third SSB at the third frequency.

At 1114, the network entity 1102 sends a first SSB corresponding to the first cell based on the first synchronization signal and a second SSB corresponding to the second cell (e.g., the one or more SSBs 816 as described with respect to FIG. 8) based on the at least second synchronization signal. For example, the network entity 1102 may send the first SSB at the first frequency and may send the second SSB at the second frequency. In some aspects, the network entity 1102 may also send a third SSB corresponding to the third cell based on the third synchronization signal. For example, the network entity 1102 may send the third SSB at the third frequency. Additionally or alternatively, separate network entities may each send a separate SSB.

Note that the process flow illustrated in FIG. 11 is an example of signaling of FMCW-based synchronization signals, and aspects of the present disclosure may be applied to FMCW-based synchronization signals for multiple cells. Note that the process flow illustrated in FIG. 11 is described herein to facilitate an understanding of FMCW-based synchronization signals for multiple cells in an SFN transmission, and aspects of the present disclosure may be performed in various manners via alternative or additional signaling and/or operations. In certain aspects, the operations and/or signaling of FIG. 11 may occur in an order different from that described or depicted, and various actions, operations, and/or signaling may be added, omitted, or combined

### Example Operations of a User Equipment

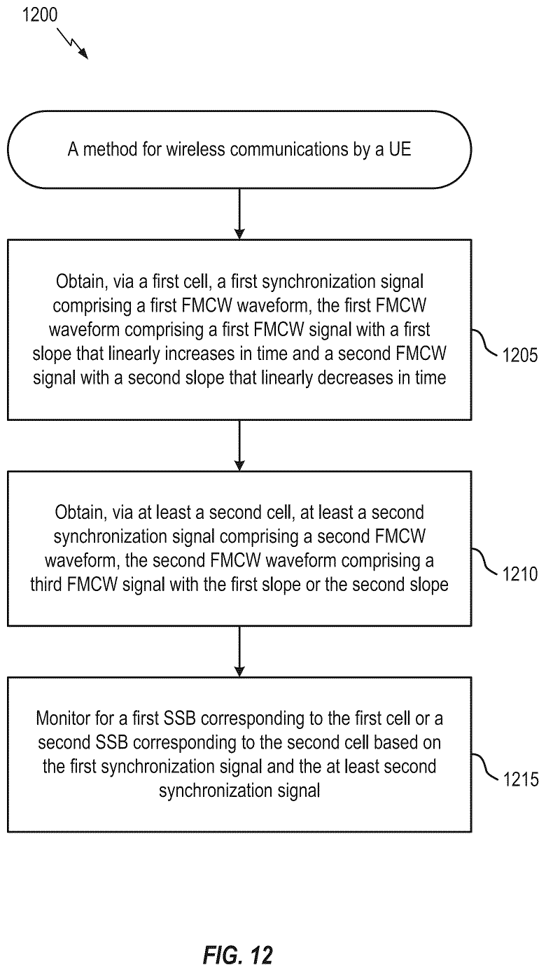

FIG. 12 shows a method 1200 for wireless communications by an apparatus, such as UE 104 of FIG. 1 or UE 304 of FIG. 3.

Method 1200 begins at block 1205 with obtaining, via a first cell, a first synchronization signal (e.g., the first synchronization signal 808 as described with respect to FIG. 8) comprising a first FMCW waveform, the first FMCW waveform comprising a first FMCW signal with a first slope that linearly increases in time and a second FMCW signal with a second slope that linearly decreases in time.

Method 1200 then proceeds to block 1210 with obtaining, via at least a second cell, at least a second synchronization signal (e.g., the at least one second synchronization signal 810 as described with respect to FIG. 8) comprising a second FMCW waveform, the second FMCW waveform comprising a third FMCW signal with the first slope or the second slope.

Method 1200 then proceeds to block 1215 with monitoring (e.g., the monitoring 814 described with respect to FIG. 8) for a first SSB corresponding to the first cell or a second SSB corresponding to the second cell based on the first synchronization signal and the at least second synchronization signal.

In some aspects, the at least second synchronization signal comprises the first FMCW waveform and the second FMCW waveform.

In some aspects, the first synchronization signal is used to modulate a first physical-layer identity corresponding to the first cell, and the second synchronization signal is used to modulate a second physical-layer identity corresponding to the second cell.

In some aspects, the first FMCW waveform comprises a first duration, the second FMCW waveform comprises a second duration, the second duration is less than the first duration, and a time difference between the first duration and the second duration indicates a physical-layer identity corresponding to the second cell.

In some aspects, the first FMCW waveform spans a first frequency range, and the second FMCW waveform spans a second frequency range.

In some aspects, the second frequency range is smaller than the first frequency range.

In some aspects, the first frequency range is the same as the second frequency range.

In some aspects, method 1200 further includes obtaining the first synchronization signal and the at least second synchronization signal in a same time-frequency resource.

In some aspects, the third FMCW signal comprises the first slope, the first FMCW signal comprises a first phase, the third FMCW signal comprises a second phase, and a differential phase between the first phase and the second phase indicates a physical-layer identity corresponding to the second cell.

In some aspects, the third FMCW signal comprises the second slope, the second FMCW signal comprises a first phase, the third FMCW signal comprises a second phase, and a differential phase between the first phase and the second phase indicates a physical-layer identity corresponding to the second cell.

In some aspects, the first FMCW signal and the second FMCW signal intersect at a first frequency, and the third FMCW signal intersects the first FMCW signal or the second FMCW signal at a second frequency.

In some aspects, block 1215 includes: monitoring for the first SSB at the first frequency; or monitoring for the second SSB at the second frequency.

In some aspects, the first FMCW waveform and the second FMCW waveform comprise a SFN transmission.

In some aspects, method 1200 further includes obtaining, via a third cell, a third synchronization signal (e.g., the third synchronization signal 812 described with respect to FIG. 8) comprising a third FMCW waveform, the third FMCW waveform comprising a fourth FMCW signal with the first slope or the second slope.

In some aspects, method 1200 further includes monitoring (e.g., the monitoring 814 described with respect to FIG. 8) for a third SSB corresponding to the third cell based on the third synchronization signal.

In some aspects, the third synchronization signal is used to modulate a third physical-layer identity corresponding to the third cell.

In some aspects, the first FMCW waveform comprises a first duration, the third FMCW waveform comprises a third duration, the third duration is less than the first duration, and a time difference between the first duration and the third duration is used to modulate a physical-layer identity corresponding to the third cell.

In some aspects, the fourth FMCW signal comprises the first slope, the first FMCW signal comprises a first phase, the fourth FMCW signal comprises a third phase, and a differential phase between the first phase and the third phase is used to modulate a physical-layer identity corresponding to the third cell.

In some aspects, the fourth FMCW signal comprises the second slope, the second FMCW signal comprises a first phase, the fourth FMCW signal comprises a third phase, and a differential phase between the first phase and the third phase is used to modulate a physical-layer identity corresponding to the third cell.

In some aspects, the fourth FMCW signal intersects the first FMCW signal or the second FMCW signal at a third frequency.

In some aspects, monitoring for the third SSB corresponding to the third cell comprises monitoring for the third SSB at the third frequency.

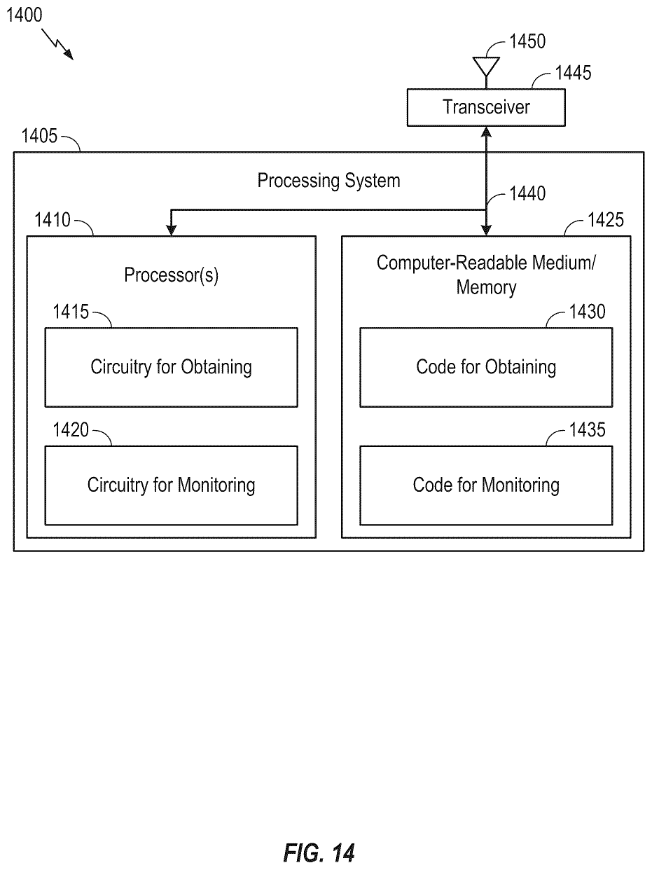

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

In certain aspects, method 1200 may be performed by the apparatus to realize one or more technical effects or solutions to the aforementioned technical problem(s). For example, based on method 1200, the techniques for using FMCW designs to support multiple cells (e.g., with SFN transmissions) may enhance wireless communications coverage for the apparatus. That is, respective synchronization signals from the multiple cells may be sent using the FMCW designs to enhance wireless communications coverage for the apparatus. For example, the apparatus may identify which synchronization signal is sent via a corresponding cell and may also identify a physical-layer identity for a given cell using the FMCW designs, such that the apparatus can then establish and/or transfer its communications to that cell to maintain connectivity. Additionally, the FMCW designs proposed herein may allow relative low complexity receiver-side circuitry at the apparatus to perform wideband channel estimation, which may help keep cost down while still providing accurate channel estimation and improved performance.

### Example Operations of a Network Entity

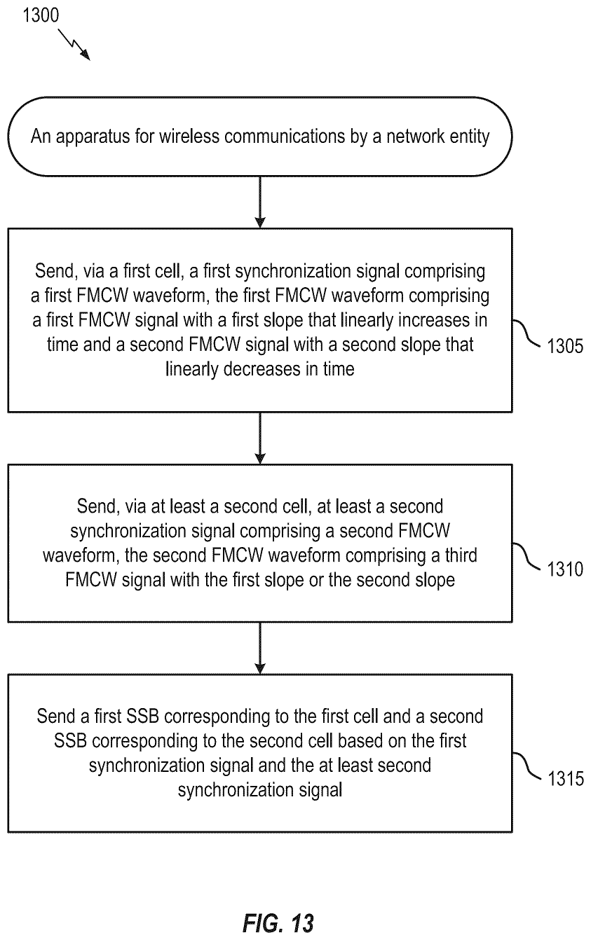

FIG. 13 shows a method 1300 for wireless communications by an apparatus, such as BS 102 of FIG. 1, a first network entity 300 or second network entity 302 of FIG. 3, or a disaggregated base station as discussed with respect to FIG. 2.

Method 1300 begins at block 1305 with sending, via a first cell, a first synchronization signal (e.g., the first synchronization signal 808 as described with respect to FIG. 8) comprising a first FMCW waveform, the first FMCW waveform comprising a first FMCW signal with a first slope that linearly increases in time and a second FMCW signal with a second slope that linearly decreases in time.

Method 1300 then proceeds to block 1310 with sending, via at least a second cell, at least a second synchronization signal (e.g., the at least one second synchronization signal 810 as described with respect to FIG. 8) comprising a second FMCW waveform, the second FMCW waveform comprising a third FMCW signal with the first slope or the second slope.

Method 1300 then proceeds to block 1315 with sending a first SSB corresponding to the first cell and a second SSB corresponding to the second cell (e.g., the one or more SSBs 816 as described with respect to FIG. 8) based on the first synchronization signal and the at least second synchronization signal.

In some aspects, the at least second synchronization signal comprises the first FMCW waveform and the second FMCW waveform.

In some aspects, the first synchronization signal is used to modulate a first physical-layer identity corresponding to the first cell, and the second synchronization signal is used to modulate a second physical-layer identity corresponding to the second cell.

In some aspects, the first FMCW waveform comprises a first duration, the second FMCW waveform comprises a second duration, the second duration is less than the first duration, and a time difference between the first duration and the second duration indicates a physical-layer identity corresponding to the second cell.

In some aspects, the first FMCW waveform spans a first frequency range, and the second FMCW waveform spans a second frequency range.

In some aspects, the second frequency range is smaller than the first frequency range.

In some aspects, the first frequency range is the same as the second frequency range.

In certain aspects, method 1300 further includes sending the first synchronization signal and the at least second synchronization signal in a same time-frequency resource.

In some aspects, the third FMCW signal comprises the first slope, the first FMCW signal comprises a first phase, the third FMCW signal comprises a second phase, and a differential phase between the first phase and the second phase indicates a physical-layer identity corresponding to the second cell.

In some aspects, the third FMCW signal comprises the second slope, the second FMCW signal comprises a first phase, the third FMCW signal comprises a second phase, and a differential phase between the first phase and the second phase indicates a physical-layer identity corresponding to the second cell.

In some aspects, the first FMCW signal and the second FMCW signal intersect at a first frequency, and the third FMCW signal intersects the first FMCW signal or the second FMCW signal at a second frequency.

In some aspects, block 1315 includes: sending the first SSB at the first frequency; and sending the second SSB at the second frequency.

In some aspects, the first FMCW waveform and the second FMCW waveform comprise a SFN transmission.

In certain aspects, method 1300 further includes sending, via a third cell, a third synchronization signal (e.g., the third synchronization signal 812 described with respect to FIG. 8) comprising a third FMCW waveform, the third FMCW waveform comprising a fourth FMCW signal with the first slope or the second slope.

In certain aspects, method 1300 further includes sending a third SSB corresponding to the third cell based on the third synchronization signal.

In some aspects, the third synchronization signal is used to modulate a third physical-layer identity corresponding to the third cell.

In some aspects, the first FMCW waveform comprises a first duration, the third FMCW waveform comprises a third duration, the third duration is less than the first duration, and a time difference between the first duration and the third duration is used to modulate a physical-layer identity corresponding to the third cell.

In some aspects, the fourth FMCW signal comprises the first slope, the first FMCW signal comprises a first phase, the fourth FMCW signal comprises a third phase, and a differential phase between the first phase and the third phase is used to modulate a physical-layer identity corresponding to the third cell.

In some aspects, the fourth FMCW signal comprises the second slope, the second FMCW signal comprises a first phase, the fourth FMCW signal comprises a third phase, and a differential phase between the first phase and the third phase is used to modulate a physical-layer identity corresponding to the third cell.

In some aspects, the fourth FMCW signal intersects the first FMCW signal or the second FMCW signal at a third frequency.

In some aspects, sending the third SSB corresponding to the third cell comprises sending the third SSB at the third frequency.

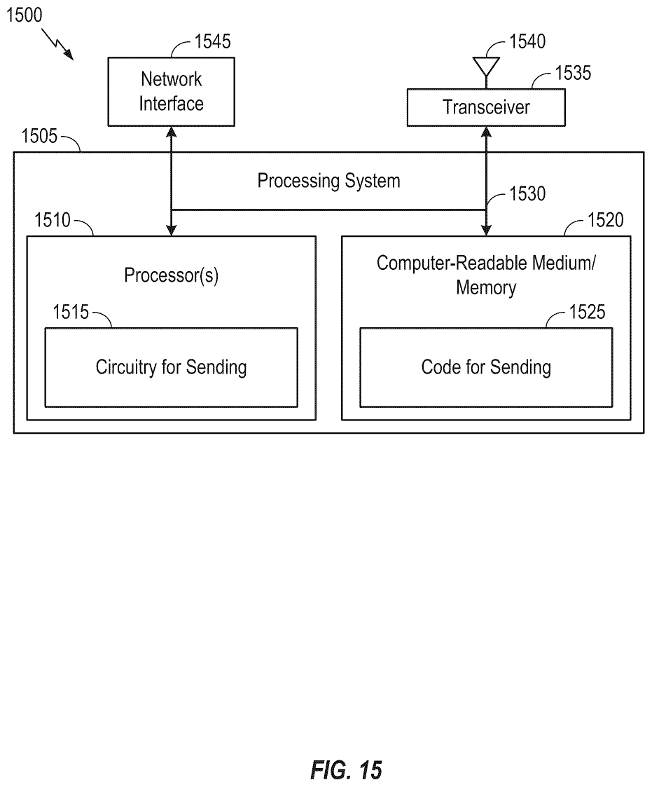

In some aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative operations are possible consistent with this disclosure.

In certain aspects, method 1300 may be performed by the apparatus to realize one or more technical effects or solutions to the aforementioned technical problem(s). For example, based on method 1300, the techniques for using FMCW designs to support multiple cells (e.g., with SFN transmissions) may enhance wireless communications coverage. That is, respective synchronization signals from the multiple cells may be sent using the FMCW designs to enhance wireless communications coverage for a UE. For example, the apparatus may modulate and/or indicate a physical-layer identity for a given cell using the FMCW designs, such that the UE can then establish and/or transfer its communications to that cell to maintain connectivity.

### Example Communications Devices

FIG. 14 depicts aspects of an example communications device 1400 configured for wireless communications. In some aspects, communications device 1400 is a user equipment, such as UE 104 described above with respect to FIG. 1 or UE 304 described with respect to FIG. 3.

The communications device 1400 includes a processing system 1405 coupled to a transceiver 1445 (e.g., a transmitter and/or a receiver). The transceiver 1445 is configured to transmit and receive signals for the communications device 1400 via an antenna 1450, such as the various signals as described herein. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, the one or more processors 1410 may be representative of the one or more processors 318 described with respect to FIG. 3. The one or more processors 1410 are coupled to a computer-readable medium/memory 1425 via a bus 1440. In some aspects, the computer-readable medium/memory 1425 may be representative of the one or more memories 320 described with respect to FIG. 3. The computer-readable medium/memory 1425 is a non-transitory computer-readable medium/memory. In certain aspects, the computer-readable medium/memory 1425 is configured to store instructions (e.g., computer-executable code), that when executed by the one or more processors 1410, cause the one or more processors 1410 to perform the method 1200 described with respect to FIG. 12, or any aspect related to it, including any operations described in relation to FIG. 12. Note that reference to a processor performing a function of communications device 1400 may include one or more processors performing that function of communications device 1400, such as in a distributed fashion.

In the depicted example, computer-readable medium/memory 1425 stores code (e.g., executable instructions), including code for obtaining 1430 and code for monitoring 1435. Processing of the code 1430 and 1435 may enable and cause the communications device 1400 to perform the method 1200 described with respect to FIG. 12, or any aspect related to it. For example, in some aspects, code for obtaining 1430 includes code for obtaining, via a first cell, a first synchronization signal comprising a first FMCW waveform, the first FMCW waveform comprising a first FMCW signal with a first slope that linearly increases in time and a second FMCW signal with a second slope that linearly decreases in time. In some aspects, code for obtaining 1430 includes code for obtaining, via at least a second cell, at least a second synchronization signal comprising a second FMCW waveform, the second FMCW waveform comprising a third FMCW signal with the first slope or the second slope. In some aspects, code for monitoring 1435 includes code for monitoring for a first SSB corresponding to the first cell or a second SSB corresponding to the second cell based on the first synchronization signal and the at least second synchronization signal.

The one or more processors 1410 include circuitry configured to implement (e.g., execute) the code stored in the computer-readable medium/memory 1425, including circuitry for obtaining 1415 and circuitry for monitoring 1420. Processing with circuitry 1415 and 1420 may enable and cause the communications device 1400 to perform the method 1200 described with respect to FIG. 12, or any aspect related to it. For example, in some aspects, circuitry for obtaining 1415 includes circuitry for obtaining, via a first cell, a first synchronization signal comprising a first FMCW waveform, the first FMCW waveform comprising a first FMCW signal with a first slope that linearly increases in time and a second FMCW signal with a second slope that linearly decreases in time. In some aspects, circuitry for obtaining 1415 includes circuitry for obtaining, via at least a second cell, at least a second synchronization signal comprising a second FMCW waveform, the second FMCW waveform comprising a third FMCW signal with the first slope or the second slope. In some aspects, circuitry for monitoring 1420 includes circuitry for monitoring for a first SSB corresponding to the first cell or a second SSB corresponding to the second cell based on the first synchronization signal and the at least second synchronization signal.

More generally, means for communicating, transmitting, sending or outputting for transmission may include the one or more transceivers 324, one or more antenna 322 and/or processing system 316 of the UE 304 illustrated in FIG. 3, transceiver 1445 and/or antenna 1450 of the communications device 1400 in FIG. 14, and/or one or more processors 1410 of the communications device 1400 in FIG. 14. Means for communicating, receiving or obtaining may include the one or more transceivers 324, one or more antennas 322, and/or processing system 316 of the UE 304 illustrated in FIG. 3, transceiver 1445 and/or antenna 1450 of the communications device 1400 in FIG. 14, and/or one or more processors 1410 of the communications device 1400 in FIG. 14.

FIG. 15 depicts aspects of an example communications device configured for wireless communications. In some aspects, communications device 1500 is a network entity, such as BS 102 of FIG. 1, first network entity 300 or second network entity 302 of FIG. 3, or a disaggregated base station as discussed with respect to FIG. 2.

The communications device 1500 includes a processing system 1505 coupled to a transceiver 1535 (e.g., a transmitter and/or a receiver) and/or a network interface 1545. The transceiver 1535 is configured to transmit and receive signals for the communications device 1500 via an antenna 1540, such as the various signals as described herein. The network interface 1545 is configured to obtain and send signals for the communications device 1500 via communications link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510 and a computer-readable medium/memory 1520. In various aspects, one or more processors 1510 may be representative of the one or more processors 308, as described with respect to FIG. 3. The one or more processors 1510 are coupled to the computer-readable medium/memory 1520 via a bus 1530. In certain aspects, the computer-readable medium/memory 1520 is configured to store instructions (e.g., computer-executable code), including code for sending 1525, that when executed by the one or more processors 1510, cause the one or more processors 1510 to perform the method 1300 described with respect to FIG. 13, or any aspect related to it, including any operations described in relation to FIG. 13. The computer-readable medium/memory 1520 is a non-transitory computer-readable medium/memory. Note that reference to a processor of communications device 1500 performing a function may include one or more processors of communications device 1500 performing that function, such as in a distributed fashion.

In the depicted example, the computer-readable medium/memory 1520 stores code (e.g., executable instructions), including code for sending 1525. Processing of the code for sending 1525 may enable and cause the communications device 1500 to perform the method 1300 described with respect to FIG. 13, or any aspect related to it. For example, in some aspects, code for sending 1525 includes code for sending, via a first cell, a first synchronization signal comprising a first FMCW waveform, the first FMCW waveform comprising a first FMCW signal with a first slope that linearly increases in time and a second FMCW signal with a second slope that linearly decreases in time. In some aspects, code for sending 1525 includes code for sending, via at least a second cell, at least a second synchronization signal comprising a second FMCW waveform, the second FMCW waveform comprising a third FMCW signal with the first slope or the second slope. In some aspects, code for sending 1525 includes code for sending a first SSB corresponding to the first cell and a second SSB corresponding to the second cell based on the first synchronization signal and the at least second synchronization signal.

The one or more processors 1510 include circuitry configured to implement (e.g., execute) the code stored in the computer-readable medium/memory 1520, including circuitry for sending 1515. Processing with circuitry for sending 1515 may enable and cause the communications device 1500 to perform the method 1300 described with respect to FIG. 13, or any aspect related to it. For example, in some aspects, circuitry for sending 1515 includes circuitry for sending, via a first cell, a first synchronization signal comprising a first FMCW waveform, the first FMCW waveform comprising a first FMCW signal with a first slope that linearly increases in time and a second FMCW signal with a second slope that linearly decreases in time. In some aspects, circuitry for sending 1515 includes circuitry for sending, via at least a second cell, at least a second synchronization signal comprising a second FMCW waveform, the second FMCW waveform comprising a third FMCW signal with the first slope or the second slope. In some aspects, circuitry for sending 1515 includes circuitry for sending a first SSB corresponding to the first cell and a second SSB corresponding to the second cell based on the first synchronization signal and the at least second synchronization signal.

Various components of the communications device 1500 may provide means for performing the method 1300 described with respect to FIG. 13, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1535, antenna 1540, and/or network interface 1545 of the communications device 1500 in FIG. 15, and/or one or more processors 1510 of the communications device 1500 in FIG. 15. Means for communicating, receiving or obtaining may include the one or more transceivers 312, one or more antennas 314, and/or processing system 306 of the first network entity 300 or the second network entity 302 illustrated in FIG. 3, transceiver 1535, antenna 1540, and/or network interface 1545 of the communications device 1500 in FIG. 15, and/or one or more processors 1510 of the communications device 1500 in FIG. 15.

### Example Clauses

Implementation examples are described in the following numbered clauses:

Clause 1: A method for wireless communications by a UE comprising: obtaining, via a first cell, a first synchronization signal comprising a first FMCW waveform, the first FMCW waveform comprising a first FMCW signal with a first slope that linearly increases in time and a second FMCW signal with a second slope that linearly decreases in time; obtaining, via at least a second cell, at least a second synchronization signal comprising a second FMCW waveform, the second FMCW waveform comprising a third FMCW signal with the first slope or the second slope; and monitoring for a first SSB corresponding to the first cell or a second SSB corresponding to the second cell based on the first synchronization signal and the at least second synchronization signal.

Clause 2: The method of Clause 1, wherein the at least second synchronization signal comprises the first FMCW waveform and the second FMCW waveform.

Clause 3: The method of any one of Clauses 1-2, wherein: the first synchronization signal is used to modulate a first physical-layer identity corresponding to the first cell, and the second synchronization signal is used to modulate a second physical-layer identity corresponding to the second cell.

Clause 4: The method of any one of Clauses 1-3, wherein: the first FMCW waveform comprises a first duration, the second FMCW waveform comprises a second duration, the second duration is less than the first duration, and a time difference between the first duration and the second duration indicates a physical-layer identity corresponding to the second cell.

Clause 5: The method of any one of Clauses 1-4, wherein: the first FMCW waveform spans a first frequency range, and the second FMCW waveform spans a second frequency range.

Clause 6: The method of Clause 5, wherein the second frequency range is smaller than the first frequency range.

Clause 7: The method of Clause 5, wherein the first frequency range is the same as the second frequency range.

Clause 8: The method of any one of Clauses 1-7, further comprising obtaining the first synchronization signal and the at least second synchronization signal in a same time-frequency resource.

Clause 9: The method of any one of Clauses 1-8, wherein: the third FMCW signal comprises the first slope, the first FMCW signal comprises a first phase, the third FMCW signal comprises a second phase, and a differential phase between the first phase and the second phase indicates a physical-layer identity corresponding to the second cell.

Clause 10: The method of any one of Clauses 1-9, wherein: the third FMCW signal comprises the second slope, the second FMCW signal comprises a first phase, the third FMCW signal comprises a second phase, and a differential phase between the first phase and the second phase indicates a physical-layer identity corresponding to the second cell.

Clause 11: The method of any one of Clauses 1-10, wherein: the first FMCW signal and the second FMCW signal intersect at a first frequency, and the third FMCW signal intersects the first FMCW signal or the second FMCW signal at a second frequency.

Clause 12: The method of Clause 11, wherein monitoring for the first SSB corresponding to the first cell or the second SSB corresponding to the second cell comprises: monitoring for the first SSB at the first frequency; or monitoring for the second SSB at the second frequency.

Clause 13: The method of any one of Clauses 1-12, wherein the first FMCW waveform and the second FMCW waveform comprise a SFN transmission.

Clause 14: The method of any one of Clauses 1-13, further comprising: obtaining, via a third cell, a third synchronization signal comprising a third FMCW waveform, the third FMCW waveform comprising a fourth FMCW signal with the first slope or the second slope; and monitoring for a third SSB corresponding to the third cell based on the third synchronization signal.

Clause 15: The method of Clause 14, wherein the third synchronization signal is used to modulate a third physical-layer identity corresponding to the third cell.

Clause 16: The method of Clause 14, wherein: the first FMCW waveform comprises a first duration, the third FMCW waveform comprises a third duration, the third duration is less than the first duration, and a time difference between the first duration and the third duration is used to modulate a physical-layer identity corresponding to the third cell.

Clause 17: The method of Clause 14, wherein: the fourth FMCW signal comprises the first slope, the first FMCW signal comprises a first phase, the fourth FMCW signal comprises a third phase, and a differential phase between the first phase and the third phase is used to modulate a physical-layer identity corresponding to the third cell.

Clause 18: The method of Clause 14, wherein: the fourth FMCW signal comprises the second slope, the second FMCW signal comprises a first phase, the fourth FMCW signal comprises a third phase, and a differential phase between the first phase and the third phase is used to modulate a physical-layer identity corresponding to the third cell.

Clause 19: The method of Clause 14, wherein the fourth FMCW signal intersects the first FMCW signal or the second FMCW signal at a third frequency.

Clause 20: The method of Clause 19, wherein monitoring for the third SSB corresponding to the third cell comprises monitoring for the third SSB at the third frequency.

Clause 21: A method for wireless communications by a network entity comprising: sending, via a first cell, a first synchronization signal comprising a first FMCW waveform, the first FMCW waveform comprising a first FMCW signal with a first slope that linearly increases in time and a second FMCW signal with a second slope that linearly decreases in time; sending, via at least a second cell, at least a second synchronization signal comprising a second FMCW waveform, the second FMCW waveform comprising a third FMCW signal with the first slope or the second slope; and sending a first SSB corresponding to the first cell and a second SSB corresponding to the second cell based on the first synchronization signal and the at least second synchronization signal.

Clause 22: The method of Clause 21, wherein the at least second synchronization signal comprises the first FMCW waveform and the second FMCW waveform.

Clause 23: The method of any one of Clauses 21-22, wherein: the first synchronization signal is used to modulate a first physical-layer identity corresponding to the first cell, and the second synchronization signal is used to modulate a second physical-layer identity corresponding to the second cell.

Clause 24: The method of any one of Clauses 21-23, wherein: the first FMCW waveform comprises a first duration, the second FMCW waveform comprises a second duration, the second duration is less than the first duration, and a time difference between the first duration and the second duration indicates a physical-layer identity corresponding to the second cell.

Clause 25: The method of any one of Clauses 21-24, wherein: the first FMCW waveform spans a first frequency range, and the second FMCW waveform spans a second frequency range.

Clause 26: The method of Clause 25, wherein the second frequency range is smaller than the first frequency range.

Clause 27: The method of Clause 25, wherein the first frequency range is the same as the second frequency range.

Clause 28: The method of any one of Clauses 21-27, further comprising sending the first synchronization signal and the at least second synchronization signal in a same time-frequency resource.

Clause 29: The method of any one of Clauses 21-28, wherein: the third FMCW signal comprises the first slope, the first FMCW signal comprises a first phase, the third FMCW signal comprises a second phase, and a differential phase between the first phase and the second phase indicates a physical-layer identity corresponding to the second cell.

Clause 30: The method of any one of Clauses 21-29, wherein: the third FMCW signal comprises the second slope, the second FMCW signal comprises a first phase, the third FMCW signal comprises a second phase, and a differential phase between the first phase and the second phase indicates a physical-layer identity corresponding to the second cell.

Clause 31: The method of any one of Clauses 21-30, wherein: the first FMCW signal and the second FMCW signal intersect at a first frequency, and the third FMCW signal intersects the first FMCW signal or the second FMCW signal at a second frequency.

Clause 32: The method of Clause 31, wherein sending the first SSB corresponding to the first cell or the second SSB corresponding to the second cell comprises: sending the first SSB at the first frequency; and sending the second SSB at the second frequency.

Clause 33: The method of any one of Clauses 21-32, wherein the first FMCW waveform and the second FMCW waveform comprise a SFN transmission.

Clause 34: The method of any one of Clauses 21-33, further comprising: sending, via a third cell, a third synchronization signal comprising a third FMCW waveform, the third FMCW waveform comprising a fourth FMCW signal with the first slope or the second slope; and sending a third SSB corresponding to the third cell based on the third synchronization signal.

Clause 35: The method of Clause 34, wherein the third synchronization signal is used to modulate a third physical-layer identity corresponding to the third cell.

Clause 36: The method of Clause 34, wherein: the first FMCW waveform comprises a first duration, the third FMCW waveform comprises a third duration, the third duration is less than the first duration, and a time difference between the first duration and the third duration is used to modulate a physical-layer identity corresponding to the third cell.

Clause 37: The method of Clause 34, wherein: the fourth FMCW signal comprises the first slope, the first FMCW signal comprises a first phase, the fourth FMCW signal comprises a third phase, and a differential phase between the first phase and the third phase is used to modulate a physical-layer identity corresponding to the third cell.

Clause 38: The method of Clause 34, wherein: the fourth FMCW signal comprises the second slope, the second FMCW signal comprises a first phase, the fourth FMCW signal comprises a third phase, and a differential phase between the first phase and the third phase is used to modulate a physical-layer identity corresponding to the third cell.

Clause 39: The method of Clause 34, wherein the fourth FMCW signal intersects the first FMCW signal or the second FMCW signal at a third frequency.

Clause 40: The method of Clause 39, wherein sending the third SSB corresponding to the third cell comprises sending the third SSB at the third frequency.

Clause 41: One or more apparatuses, comprising: one or more memories comprising executable instructions; and one or more processors configured to execute the executable instructions and cause the one or more apparatuses to perform a method in accordance with any one of Clauses 1-40.

Clause 42: One or more apparatuses configured for wireless communications, comprising: one or more memories; and one or more processors, coupled to the one or more memories, configured to cause the one or more apparatuses to perform a method in accordance with any one of Clauses 1-40.

Clause 43: One or more apparatuses configured for wireless communications, comprising: one or more memories; and one or more processors, coupled to the one or more memories, configured to perform a method in accordance with any one of Clauses 1-40.

Clause 44: One or more apparatuses, comprising means for performing a method in accordance with any one of Clauses 1-40.

Clause 45: One or more non-transitory computer-readable media comprising executable instructions that, when executed by one or more processors of one or more apparatuses, cause the one or more apparatuses to perform a method in accordance with any one of Clauses 1-40.

Clause 46: One or more computer program products embodied on one or more computer-readable storage media comprising code for performing a method in accordance with any one of Clauses 1-40.

Clause 47: One or more apparatuses configured for wireless communications, comprising: a processing system that includes one or more processors and one or more memories coupled with the one or more processors, the processing system configured to cause the one or more apparatuses to perform a method in accordance with any one of Clauses 1-40.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain, via a first cell, a first synchronization signal comprising a first frequency-modulated continuous wave (FMCW) waveform, the first FMCW waveform comprising a first FMCW signal with a first slope that linearly increases in time and a second FMCW signal with a second slope that linearly decreases in time;
obtain, via at least a second cell, at least a second synchronization signal comprising a second FMCW waveform, the second FMCW waveform comprising a third FMCW signal with the first slope or the second slope; and
monitor for a first synchronization signal block (SSB) corresponding to the first cell or a second SSB corresponding to the second cell based on the first synchronization signal and the at least second synchronization signal.

2. The apparatus of claim 1, wherein the at least second synchronization signal comprises the first FMCW waveform and the second FMCW waveform.

3. The apparatus of claim 1, wherein:
the first synchronization signal is used to modulate a first physical-layer identity corresponding to the first cell, and
the second synchronization signal is used to modulate a second physical-layer identity corresponding to the second cell.

4. The apparatus of claim 1, wherein:
the first FMCW waveform comprises a first duration,
the second FMCW waveform comprises a second duration,
the second duration is less than the first duration, and
a time difference between the first duration and the second duration indicates a physical-layer identity corresponding to the second cell.

5. The apparatus of claim 1, wherein:
the first FMCW waveform spans a first frequency range, and
the second FMCW waveform spans a second frequency range.

6. The apparatus of claim 5, wherein the second frequency range is smaller than the first frequency range.

7. The apparatus of claim 5, wherein the first frequency range is the same as the second frequency range.

8. The apparatus of claim 1, wherein the processing system is configured to cause the UE to obtain the first synchronization signal and the at least second synchronization signal in a same time-frequency resource.

9. The apparatus of claim 1, wherein:
the third FMCW signal comprises the first slope,
the first FMCW signal comprises a first phase,
the third FMCW signal comprises a second phase, and
a differential phase between the first phase and the second phase indicates a physical-layer identity corresponding to the second cell.

10. The apparatus of claim 1, wherein:
the third FMCW signal comprises the second slope,
the second FMCW signal comprises a first phase,
the third FMCW signal comprises a second phase, and
a differential phase between the first phase and the second phase indicates a physical-layer identity corresponding to the second cell.

11. The apparatus of claim 1, wherein:
the first FMCW signal and the second FMCW signal intersect at a first frequency, and
the third FMCW signal intersects the first FMCW signal or the second FMCW signal at a second frequency.

12. The apparatus of claim 11, wherein to monitor for the first SSB corresponding to the first cell or the second SSB corresponding to the second cell, the processing system is configured to cause the UE to:
monitor for the first SSB at the first frequency; or
monitor for the second SSB at the second frequency.

13. The apparatus of claim 1, wherein the first FMCW waveform and the second FMCW waveform comprise a single-frequency network (SFN) transmission.

14. The apparatus of claim 1, wherein the processing system is configured to cause the UE to:
obtain, via a third cell, a third synchronization signal comprising a third FMCW waveform, the third FMCW waveform comprising a fourth FMCW signal with the first slope or the second slope; and
monitor for a third SSB corresponding to the third cell based on the third synchronization signal.

15. The apparatus of claim 14, wherein the third synchronization signal is used to modulate a third physical-layer identity corresponding to the third cell.

16. The apparatus of claim 14, wherein:
the first FMCW waveform comprises a first duration,
the third FMCW waveform comprises a third duration,
the third duration is less than the first duration, and
a time difference between the first duration and the third duration is used to modulate a physical-layer identity corresponding to the third cell.

17. The apparatus of claim 14, wherein:
the fourth FMCW signal comprises the first slope,
the first FMCW signal comprises a first phase,
the fourth FMCW signal comprises a third phase, and
a differential phase between the first phase and the third phase is used to modulate a physical-layer identity corresponding to the third cell.

18. The apparatus of claim 14, wherein:
the fourth FMCW signal comprises the second slope,
the second FMCW signal comprises a first phase,
the fourth FMCW signal comprises a third phase, and
a differential phase between the first phase and the third phase is used to modulate a physical-layer identity corresponding to the third cell.

19. The apparatus of claim 14, wherein the fourth FMCW signal intersects the first FMCW signal or the second FMCW signal at a third frequency.

20. The apparatus of claim 19, wherein to monitor for the third SSB corresponding to the third cell, the processing system is configured to cause the UE to monitor for the third SSB at the third frequency.

21. An apparatus for wireless communications, comprising a processing system that includes one or more processors and one or more memories coupled with the one or more processors, the processing system configured to cause a network entity to:
send, via a first cell, a first synchronization signal comprising a first frequency-modulated continuous wave (FMCW) waveform, the first FMCW waveform comprising a first FMCW signal with a first slope that linearly increases in time and a second FMCW signal with a second slope that linearly decreases in time;
send, via at least a second cell, at least a second synchronization signal comprising a second FMCW waveform, the second FMCW waveform comprising a third FMCW signal with the first slope or the second slope; and
send a first synchronization signal block (SSB) corresponding to the first cell and a second SSB corresponding to the second cell based on the first synchronization signal and the at least second synchronization signal.

22. The apparatus of claim 21, wherein the at least second synchronization signal comprises the first FMCW waveform and the second FMCW waveform.

23. The apparatus of claim 21, wherein:
the first synchronization signal is used to modulate a first physical-layer identity corresponding to the first cell, and
the second synchronization signal is used to modulate a second physical-layer identity corresponding to the second cell.

24. The apparatus of claim 21, wherein:
the first FMCW waveform comprises a first duration,
the second FMCW waveform comprises a second duration,
the second duration is less than the first duration, and
a time difference between the first duration and the second duration indicates a physical-layer identity corresponding to the second cell.

25. The apparatus of claim 21, wherein:
the first FMCW waveform spans a first frequency range, and
the second FMCW waveform spans a second frequency range.

26. The apparatus of claim 25, wherein the second frequency range is smaller than the first frequency range.

27. The apparatus of claim 25, wherein the first frequency range is the same as the second frequency range.

28. The apparatus of claim 21, wherein the processing system is configured to cause the network entity to send the first synchronization signal and the at least second synchronization signal in a same time-frequency resource.

29. A method for wireless communications by a user equipment (UE) comprising:
obtaining, via a first cell, a first synchronization signal comprising a first frequency-modulated continuous wave (FMCW) waveform, the first FMCW waveform comprising a first FMCW signal with a first slope that linearly increases in time and a second FMCW signal with a second slope that linearly decreases in time;
obtaining, via at least a second cell, at least a second synchronization signal comprising a second FMCW waveform, the second FMCW waveform comprising a third FMCW signal with the first slope or the second slope; and
monitoring for a first synchronization signal block (SSB) corresponding to the first cell or a second SSB corresponding to the second cell based on the first synchronization signal and the at least second synchronization signal.

30. A method for wireless communications by a network entity comprising:
sending, via a first cell, a first synchronization signal comprising a first frequency-modulated continuous wave (FMCW) waveform, the first FMCW waveform comprising a first FMCW signal with a first slope that linearly increases in time and a second FMCW signal with a second slope that linearly decreases in time;
sending, via at least a second cell, at least a second synchronization signal comprising a second FMCW waveform, the second FMCW waveform comprising a third FMCW signal with the first slope or the second slope; and
sending a first synchronization signal block (SSB) corresponding to the first cell and a second SSB corresponding to the second cell based on the first synchronization signal and the at least second synchronization signal.
